(19) United States
(12) Patent Application Publication
(10) Pub. No.: US 2014/0292690 A1
(43) Pub. Date: Oct. 2, 2014

(54) INFORMATION PROCESSING SYSTEM, INFORMATION PROCESSING APPARATUS, AND BRUSH APPARATUS

(71) Applicant: SONY CORPORATION, Tokyo (JP)

(72) Inventor: Kenji Sugihara, Nagano (JP)

(73) Assignee: SONY CORPORATION, Tokyo (JP)

(21) Appl. No.: 14/221,799

(22) Filed: Mar. 21, 2014

(30) Foreign Application Priority Data
Mar. 28, 2013 (JP) 2013-068827

(51) Int. Cl. G06F 3/0354; G06T 11/20

(52) U.S. Cl. CPC G06F 3/03545; G06T 11/20
USPC 345/173

(57) ABSTRACT

There is provided an information processing system including a brush apparatus that fulfills a role of a brush, and an information processing apparatus that causes drawing according to an operation on an operating surface by the brush apparatus to be conducted on a display screen.

### CROSS REFERENCE TO RELATED APPLICATIONS

This application claims the benefit of Japanese Priority Patent Application JP 2013-068827 filed Mar. 28, 2013, the entire contents of which are incorporated herein by reference.

### BACKGROUND

The present disclosure relates to an information processing system, an information processing apparatus, and a brush apparatus.

Technology is being developed in which a brush-shaped device, such as a brush-shaped stylus, for example, is used in order to realize drawing as though a letter or picture is drawn with a brush onto paper or the like. The technology described in JP 2010-277330A may be cited as an example of the above technology for realizing drawing as through a letter or picture is drawn with a brush onto paper or the like.

### SUMMARY

For example, with existing technology for realizing drawing as though a letter or picture is drawn with a brush onto paper or the like, such as the technology described in JP 2010-277330A (hereinafter simply designated “existing technology” in some cases), contact regions are estimated on a device that fulfills the role of a brush, and an operating surface that is operated on by that device (that is, a surface that corresponds to what may be called the “canvas”). Consequently, by using existing technology such as the technology described in JP 2010-277330A, for example, there is a possibility of realizing drawing as though drawn with a brush.

However, with existing technology such as the technology described in JP 2010-277330A, for example, the contact region on the side of the device that fulfills the role of a brush is estimated from the contact region on the side of the operating surface. Consequently, in the case of using existing technology such as the technology described in JP 2010-277330A, for example, there is a risk of incorrectly estimating the contact region on the side of the device that fulfills the role of a brush, which is influenced by the successively varying orientation of the device.

Consequently, even if existing technology is used, there is no guarantee of being able to realize drawing as though actually drawn with a brush.

The present disclosure proposes a new and improved information processing system, information processing apparatus, and brush apparatus capable of realizing drawing as though actually drawn with a brush.

According to an embodiment of the present disclosure, there is provided an information processing system including a brush apparatus that fulfills a role of a brush, and an information processing apparatus that causes drawing according to an operation on an operating surface by the brush apparatus to be conducted on a display screen. The brush apparatus includes a tip unit that fulfills a role of a tip on the brush, a curvature information acquisition unit that acquires curvature information indicating a curvature state of the tip unit due to an operation on the operating surface, an orientation information acquisition unit that acquires brush apparatus orientation information indicating an orientation of the brush apparatus, and a communication control unit that causes the curvature information and the brush apparatus orientation information to be transmitted to the information processing apparatus. The information processing apparatus includes a contact region estimation unit that estimates a contact region on the tip unit of the brush apparatus and the operating surface, on a basis of the curvature information and the brush apparatus orientation information transmitted from the brush apparatus, and position information indicating a contact position of the tip unit of the brush apparatus on the operating surface, and a drawing processing unit that causes drawing according to an operation on the operating surface by the brush apparatus to be conducted on the display screen, on a basis of estimation results for the contact region.

According to an embodiment of the present disclosure, there is provided an information processing device including a contact region estimation unit that estimates a contact region on a tip unit, which fulfills a role of a tip on a brush of a brush apparatus that fulfills a role of a brush, and an operating surface, on a basis of curvature information indicating a curvature state of the tip unit of the brush apparatus with respect to the operating surface and brush apparatus orientation information indicating an orientation of the brush apparatus, which are transmitted from the brush apparatus, and position information indicating a contact position of the tip unit of the brush apparatus on the operating surface, and a drawing processing unit that causes drawing according to an operation on the operating surface by the brush apparatus to be conducted on a display screen, on a basis of estimation results for the contact region.

According to an embodiment of the present disclosure, there is provided a brush apparatus including a tip unit that fulfills a role of a tip on a brush, a curvature information acquisition unit that acquires curvature information indicating a curvature state of the tip unit with respect to an operating surface, an orientation information acquisition unit that acquires orientation information indicating an orientation of the brush apparatus, and a communication control unit that causes the curvature information and the orientation information to be transmitted to an information processing apparatus that causes drawing according to an operation on the operating surface by the brush apparatus to be conducted on a display screen.

According to an embodiment of the present disclosure, drawing as though actually drawn with a brush may be realized.

### BRIEF DESCRIPTION OF THE DRAWINGS

FIG. 1 is an explanatory diagram illustrating an example of an information processing system according to the present embodiment;

FIG. 2 is an explanatory diagram for describing an example of a process by an information processing apparatus according to the present embodiment;

FIG. 3 is an explanatory diagram for describing an example of a process by an information processing apparatus according to the present embodiment;

FIG. 4 is an explanatory diagram for describing an example of a process by an information processing apparatus according to the present embodiment;

FIG. 5 is an explanatory diagram for describing an example of a process by an information processing apparatus according to the present embodiment;

FIG. 6 is an explanatory diagram for describing an example of a process by an information processing apparatus according to the present embodiment;

FIG. 7 is an explanatory diagram for describing an example of a color management process by an information processing apparatus according to the present embodiment;

FIG. 8 is an explanatory diagram for describing an example of a color management process by an information processing apparatus according to the present embodiment;

FIG. 9 is an explanatory diagram for describing an example of a color management process by an information processing apparatus according to the present embodiment;

FIG. 10 is a flowchart for describing an example of a process by an information processing system according to the present embodiment;

FIG. 11 is a flowchart for describing an example of a process by an information processing system according to the present embodiment;

FIG. 12 is a flowchart for describing an example of a process by an information processing system according to the present embodiment;

FIG. 13 is a flowchart for describing an example of a process by an information processing system according to the present embodiment;

FIG. 14 is a flowchart for describing an example of a process by an information processing system according to the present embodiment;

FIG. 15 is a flowchart for describing an example of a process by an information processing system according to the present embodiment;

FIG. 16 is a flowchart for describing an example of a process by an information processing system according to the present embodiment;

FIG. 17 is a flowchart for describing an example of a process by an information processing system according to the present embodiment;

FIG. 18 is a block diagram illustrating an exemplary configuration of a brush apparatus according to the present embodiment;

FIG. 19 is a block diagram illustrating an exemplary configuration of an information processing apparatus according to the present embodiment; and

FIG. 20 is an explanatory diagram illustrating an exemplary hardware configuration of an information processing apparatus according to the present embodiment.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

The description hereinafter will proceed in the following order.

1. Information processing system according to present embodiment

2. Program according to present embodiment

### (Information Processing System According to Present Embodiment)

### Process by Information Processing System According to Present Embodiment

Before describing the configurations of the respective apparatus constituting a control system according to the present embodiment, first, a process by an information processing system according to the present embodiment will be described. Hereinafter, a process by an information processing system according to the present embodiment will be described, while presenting an example of an information processing system according to the present embodiment.

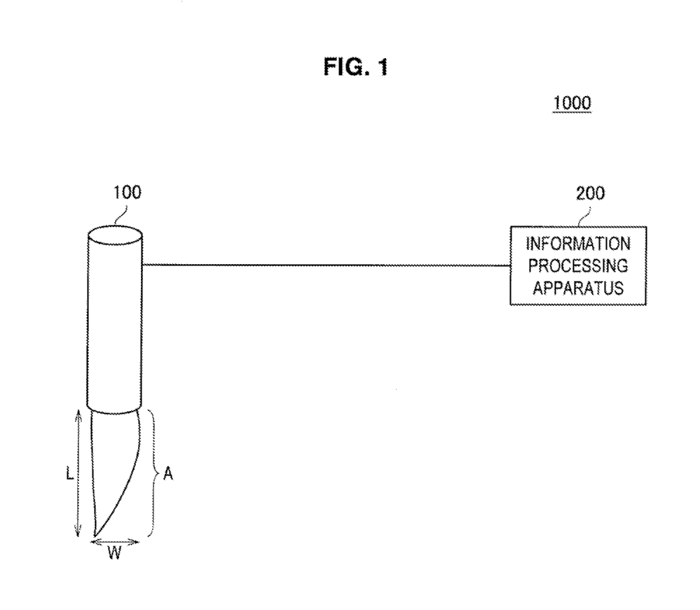

FIG. 1 is an explanatory diagram illustrating an example of an information processing system 1000 according to the present embodiment. The information processing system 1000 includes a brush apparatus 100 and an information processing apparatus 200. The brush apparatus 100 and the information processing apparatus 200 communicated in a wired or wireless manner via a communication unit (discussed later) provided in each apparatus, or via an external communication device connected to each apparatus, for example. In addition, the brush apparatus 100 and the information processing apparatus 200 communicate via a network, or directly, for example.

Herein, a network according to the present embodiment may be, for example, a wired network such as a local area network (LAN) or wide area network (WAN), a wireless network such as a wireless local area network (WLAN) or a wireless wide area network (WWAN) via a base station, or the Internet using a communication protocol such as Transmission Control Protocol/Internet Protocol (TCP/IP).

Note that, although FIG. 1 illustrates the information processing system 1000 as including one brush apparatus 100, the configuration of an information processing system according to the present embodiment is not limited to the example illustrated in FIG. 1. For example, an information processing system according to the present embodiment may also be configured to include multiple brush apparatus 100. In the case in which an information processing system according to the present embodiment includes multiple brush apparatus 100, the information processing apparatus 200 conducts the process discussed later for each of the multiple information processing apparatus 200, for example. Also, an information processing system according to the present embodiment may also be configured to include multiple information processing apparatus 200, for example. The description hereinafter will take as an example the case in which the configuration of the information processing system according to the present embodiment is the configuration illustrated in FIG. 1.

### [1-1] Process by Brush Apparatus 100

The brush apparatus 100 is an apparatus that fulfills the role of a brush. As illustrated in FIG. 1, for example, the brush apparatus 100 includes a tip unit (the portion labeled A in FIG. 1, to be discussed later) that fulfills the role of the tip of a brush. Herein, “W” illustrated in FIG. 1 indicates the width of the tip of the tip unit (expressed in units such as mm or cm, for example), while “L” illustrated in FIG. 1 indicates the length of the tip of the tip unit (expressed in units such as mm or cm, for example).

Also, although a stylus-shaped apparatus as illustrated in FIG. 1 is given as an example of a brush apparatus according to the present embodiment, a brush apparatus according to the present embodiment is not limited to the above. For example, a brush apparatus according to the present embodiment may also be an attachment-shaped apparatus that attaches to an existing stylus and is used together with the existing stylus. The description hereinafter will take as an example the case in which the brush apparatus according to the present embodiment is a stylus-shaped apparatus as illustrated in FIG. 1. Note that in the case in which a brush apparatus according to the present embodiment is a stylus-shaped apparatus as illustrated in FIG. 1, the outward appearance of the brush apparatus according to the present embodiment is obviously not limited to the example illustrated in FIG. 1.

A user using the brush apparatus 100 draws a letter or picture using the brush apparatus 100 by causing the tip unit of the brush apparatus 100 to contact an operating surface (not illustrated in FIG. 1).

Herein, an operating surface according to the present embodiment may be, for example, a pointing device detection surface capable of detecting a contact position by various methods such as optical, capacitive, or inductive methods, or a touch panel display screen (detection surface) capable of detecting a contact position by various methods such as the above. In addition, an operating surface according to the present embodiment may also be, for example, the display screen of a display unit provided in the information processing apparatus 200 (discussed later), the detection surface of a pointing device provided in the information processing apparatus 200, or the display screen or detection surface of an external device to the information processing apparatus 200. The description hereinafter will primarily take as an example the case in which the operating surface according to the present embodiment is the display screen of a display unit provided in the information processing apparatus 200 (discussed later).

Also, a tip unit according to the present embodiment may be, for example, the tip of a real brush, or a conical cap resembling a brush tip (for example, a cap covering a device constituting a curvature information acquisition unit to be discussed later).

By configuring a tip unit according to the present embodiment with a member like the above, it becomes possible to give the user using the brush apparatus 100 a tactile sensation as though the user were actually using a real brush. Also, by giving a tip unit according to the present embodiment a cap shape, it becomes possible to easily realize a shape like that of a wet brush, and given the user a tactile sensation as though the user were using a brush with a wet tip.

In addition, a tip unit according to the present embodiment may also configured such that a member like the above is replaceable. By taking a configuration in which a member like the above is replaceable, the flexibility of being able to change the tip specifications is realized.

Also, the material of a member constituting a tip unit according to the present embodiment is selected with consideration for the material of an operating surface according to the present embodiment, for example. By selecting the material of a member constituting a tip unit according to the present embodiment with consideration for the material of an operating surface according to the present embodiment, it becomes possible to impart a tactile sensation as though actually using a real brush.

Also, the material of a member constituting a tip unit according to the present embodiment may be selected with consideration for the shape after operating on an operating surface according to the present embodiment, for example. With the above material selection, it becomes possible to realize a configuration in which the shape of a tip unit according to the present embodiment returns to the pre-operation shape after operating on an operating surface according to the present embodiment, or a configuration in which the shape of a tip unit according to the present embodiment keeps the post-operation shape after operating on an operating surface according to the present embodiment, for example. Consequently, with the above material selection, for example, it is possible to give the user a tactile sensation as though the user were actually using a real brush.

Furthermore, a tip unit according to the present embodiment may also be equipped with a pointing function that corresponds to the contact position detection method of the device constituting the operating surface, for example. For example, in the case in which the device constituting the operating surface detects a contact position with a capacitive method, a material that corresponds to (reacts to) the capacitive method is used as the material of the tip unit according to the present embodiment. As another example, in the case in which the device constituting the operating surface detects a contact position with an inductive method, the tip unit according to the present embodiment has a configuration in which a lead connected to the core of an existing digitizer extends to the tip, for example. Note that in the case in which the device constituting the operating surface detects a contact position with an optical method, the tip unit according to the present embodiment does not require any particular pointing mechanism.

If an operation is performed on the operating surface, the brush apparatus 100 transmits information (data) corresponding to the operation on the operating surface to the information processing apparatus 200 via a communication unit (discussed later) provided in the brush apparatus 100 or an external communication device. The information corresponding an operation on the operating surface that the brush apparatus 100 transmits to the information processing apparatus 200 according to the present embodiment may be, for example, curvature information, and brush apparatus orientation information (orientation information).

Herein, curvature information according to the present embodiment refers to information (data) indicating the curvature state of the tip unit due to an operation on the operating surface. Curvature information according to the present embodiment may be, for example, data indicating a curvature magnitude of the tip unit with respect to the operating surface, data indicating a curvature direction of the tip unit with respect to the operating surface, or data indicating a curvature magnitude and a curvature direction.

The brush apparatus 100 acquires curvature information by being equipped with a curvature information acquisition unit. More specifically, the brush apparatus 100 acquires curvature information with a configuration and process indicated in (i) to (iii) below, for example.

### (i) First Example of Configuration and Process Related to Curvature Information Acquisition

The curvature information acquisition unit includes an analog switch, for example. The curvature information acquisition unit takes curvature information to be information based on an analog magnitude that corresponds to the degree of tilt of the analog stick. Herein, information based on an analog magnitude according to the present embodiment may be data that has been converted into digital data, in which an analog magnitude is expressed by a designated range.

For example, the curvature information acquisition unit is equipped with an analog-to-digital converter (AD converter), and acquires curvature information by converting an analog signal that corresponds to the degree of tilt of the analog stick into a digital signal.

Herein, the AD converter provided in the curvature information acquisition unit has a fixed resolution irrespective of the size of the tip unit, for example. However, the resolution of the AD converter provided in the curvature information acquisition unit is not limited to the above.

For example, the AD converter provided in the curvature information acquisition unit may also have a resolution set according to the size of the tip unit. By setting a resolution according to the size of the tip unit, the brush apparatus 100 is able to acquire curvature information that includes data indicating a curvature magnitude according to the size of the tip unit, for example.

In the case in which the resolution of the AD converter is set according to the size of the tip unit, the brush apparatus 100 (for example, a control unit of the brush apparatus 100 discussed later) sets a resolution according to the size of the tip unit on the basis of information related to the shape of the tip unit. Herein, information related to the shape of the tip unit according to the present embodiment may be, for example, data indicating the width “W” of the tip of the tip unit, and data indicating the length “L” of the tip of the tip unit. Additionally, information related to the shape of the tip unit of the brush apparatus 100 according to the present embodiment may also include data indicating a brush type.

The brush apparatus 100 uses a table or the like in which values related to the size of the tip unit (for example, the width and/or the length of the tip) are associated with settings data that sets the resolution of the AD converter, and specifies the settings data corresponding to the value indicated by information related to the size of the tip unit. Subsequently, the brush apparatus 100 uses the specified settings data to set the resolution of the AD converter. Herein, in the case in which the curvature information acquisition unit is equipped with multiple AD converters with different resolutions, the brush apparatus 100 sets a resolution by activating an AD converter that corresponds to the settings data from among the multiple AD converters, for example. Also, in the case in which the curvature information acquisition unit is equipped with an AD converter with variable resolution, the brush apparatus 100 transmits a control signal corresponding to the settings data to that AD converter, and causes that AD converter to set a resolution corresponding to the settings data, for example.

Additionally, a designated range according to the present embodiment may be from 0 to 255, for example. Obviously, a designated range according to the present embodiment is not limited to being from 0 to 255.

In the case in which the curvature information acquisition unit includes an analog stick as above, for example, the curvature information acquisition unit may be realized with a simple and low-cost mechanism.

### (ii) Second Example of Configuration and Process Related to Curvature Information Acquisition

Among conductive materials, there exist materials whose resistance values vary according to curvature position. For example, in the case in which the tip unit includes a conductive material whose resistance values vary according to curvature position, the curvature information acquisition unit may utilize the above property to estimate the curvature state of the tip unit from the distribution of resistance values on the tip unit. In the case of estimating the curvature state of the tip unit from a distribution of resistance values on the tip unit, the curvature information acquisition unit treats data indicating the estimation result as the curvature information.

Herein, by using a table or the like in which resistance values are associated with values indicating curvature states, for example, the curvature information acquisition unit specifies a curvature state at respective positions on the tip unit, and estimates the curvature state of the tip unit overall. The curvature information acquisition unit, on the basis of information related to the shape of the tip unit, for example, may also use a table or the like corresponding to the size of the tip unit from among multiple tables that correspond to sizes of the tip unit. For example, by using a table or the like corresponding to the size of the tip unit, it becomes possible to estimate the curvature state according to the size of the tip unit, and thus the brush apparatus 100 may acquire curvature information corresponding to the size of the tip unit.

However, a process related to curvature information acquisition according to the second example is not limited to the above. For example, it is possible for the curvature information acquisition unit to use an arbitrary method that enables estimation of the curvature state of the tip unit from a distribution of resistance values on the tip unit.

Additionally, data indicating an estimation result in a process according to the second example may be, for example, digital data in which a curvature state is expressed by a designated range, similarly to the process according to the first example indicated in the above (i). Obviously, data indicating an estimation result in a process according to the second example is not limited to the above.

(iii) Third Example of Configuration and Process Related to Curvature Information Acquisition

The curvature information acquisition unit may also estimate the curvature state of the tip unit on the basis of the relative positions of a first detection point and a second detection point on the tip unit. In the case of estimating the curvature state of the tip unit on the basis of the relative positions of a first detection point and a second detection point on the tip unit, the curvature information acquisition unit treats data indicating the estimation result as the curvature information.

Herein, a first detection point and a second detection point on the tip unit according to the present embodiment may be, for example, a position corresponding to the tip and a position corresponding to the root of the tip unit. Obviously, a first detection point and a second detection point on the tip unit according to the present embodiment are not limited to the above positions.

As another example, in the case in which the tip unit has a mechanism of detecting the positions of a set first detection point and second detection point, the curvature information acquisition unit acquires data indicating the position of the first detection point and data indicating the position of the second detection point from the tip unit. Also, in the case in which an external apparatus external to the brush apparatus 100 (for example, a device attached to the first detection point and the second detection point on the tip unit) detects the positions of the first detection point and the second detection point, the curvature information acquisition unit acquires data indicating the position of the first detection point and data indicating the position of the second detection point from that external apparatus. Note that the above mechanism and the above external apparatus related to detecting the positions of a first detection point and a second detection point take an arbitrary configuration enabling the positions to be detected, for example.

By using a table or the like in which relative positions of the first detection point and the second detection point are associated with values indicating the curvature state of the tip unit overall, for example, the curvature information acquisition unit estimates the curvature state of the tip unit that corresponds to the relative positions of the first detection point and the second detection point. The curvature information acquisition unit, on the basis of information related to the shape of the tip unit, for example, may also use a table or the like corresponding to the size of the tip unit from among multiple tables that correspond to sizes of the tip unit. For example, by using a table or the like corresponding to the size of the tip unit, it becomes possible to estimate the curvature state according to the size of the tip unit, and thus the brush apparatus 100 may acquire curvature information corresponding to the size of the tip unit.

However, a process related to curvature information acquisition according to the third example is not limited to the above. It is possible for the curvature information acquisition unit to use an arbitrary method that enables estimation of the curvature state of the tip unit from the relative positions of a first detection unit and a second detection unit.

Additionally, data indicating an estimation result in a process according to the third example may be, for example, digital data in which a curvature state is expressed by a designated range, similarly to the process according to the first example indicated in the above (i). Obviously, data indicating an estimation result in a process according to the third example is not limited to the above.

The brush apparatus 100 acquires curvature information with the configurations and processes like that indicated in the above (i) to (iii), for example. Obviously, the configuration and process related to curvature information acquisition in a brush apparatus 100 according to the present embodiment is not limited to the examples indicated in the above (i) to (iii).

Hereinafter, a process by the information processing system 1000 according to the present embodiment will be described by taking as an example the case of acquiring curvature information with a configuration and process like that indicated in the above (i), or in other words, the case in which the brush apparatus 100 is equipped with a curvature information acquisition unit that includes an analog stick.

Also, brush apparatus orientation information according to the present embodiment refers to information (data) indicating the orientation of the brush apparatus 100. Brush apparatus orientation information according to the present embodiment may be, for example, data indicating detection values from various sensors (hereinafter collectively designated the “orientation sensor” in some cases) that detect values that are usable for the detection of the orientation of the brush apparatus 100, such as an acceleration sensor, a gyro sensor, and a geomagnetic sensor. In addition, brush apparatus orientation information according to the present embodiment may also be, for example, data indicating a value which indicates an orientation and which is computed from a detection value detected by the orientation sensor according to an arbitrary method enabling the computation of a value related to orientation.

The brush apparatus 100 acquires brush apparatus orientation information by acquiring a detection value detected by the orientation sensor. Herein, the orientation sensor related to the acquisition of brush apparatus orientation information may be, for example, provided in the brush apparatus 100, or an external device to the brush apparatus 100 (for example, an orientation sensor that attaches to the brush apparatus 100 and is connected to the brush apparatus 100).

Herein, in the case in which the brush apparatus orientation information according to the present embodiment is data indicating a detection value of an orientation sensor, the brush apparatus 100 treats data indicating a detection value transmitted from the orientation sensor as brush apparatus orientation information according to the present embodiment, for example. In the case in which the brush apparatus orientation information according to the present embodiment is data indicating a detection value transmitted from the orientation sensor, the information processing apparatus 200 uses the detection value indicating the brush apparatus orientation information according to the present embodiment to compute a value indicating the orientation of the brush apparatus 100, and uses a value indicating the computed orientation of the brush apparatus 100 in a process, for example.

As another example, in the case in which the brush apparatus orientation information according to the present embodiment is data indicating a value that indicates an orientation, the brush apparatus 100 uses a detection value indicating data transmitted from the orientation sensor to compute a value indicating an orientation, and treats data indicating the computed value that indicates an orientation as brush apparatus orientation information according to the present embodiment. In the case in which the brush apparatus orientation information according to the present embodiment is data indicating a value that indicates an orientation computed on the basis of a detection value transmitted from the orientation sensor, the information processing apparatus 200 uses the value indicating the brush apparatus orientation information according to the present embodiment in a process as a value indicating the orientation of the brush apparatus 100, for example.

### [1-2] Process by Information Processing Apparatus 200

The information processing apparatus 200 causes drawing according to operations on an operating surface by the brush apparatus 100 to be conducted on a display screen. More specifically, the information processing apparatus 200 causes drawing according to operations performed on an operating surface by the brush apparatus 100 to be conducted on a display screen by conducting the contact region estimation process and the drawing process indicated below, for example.

### (1) Contact Region Estimation Process

The information processing apparatus 200 estimates contact regions on the tip unit of the brush apparatus 100 and the operating surface on the basis of information corresponding to operations on the operating surface transmitted from the brush apparatus 100 (curvature information and brush apparatus orientation information), and position information indicating the contact position of a tip unit 102 of the brush apparatus on the operating surface, for example. In addition, it is also possible for the information processing apparatus 200 to estimate contact regions on the tip unit of the brush apparatus 100 and the operating surface on the additional basis of operating surface orientation information (orientation information), for example.

Herein, position information according to the present embodiment may be, for example, data indicating a contact position (for example, data indicating coordinates on the operating surface) detected by a device capable of detecting a contact position, such as a pointing device or touch panel constituting the operating surface, for example. The information processing apparatus 200 acquires position information by acquiring data indicating a contact position from the above device constituting the operating surface, for example.

Also, operating surface orientation information according to the present embodiment refers to information (data) indicating the orientation of the operating surface. Operating surface orientation information according to the present embodiment may be, for example, data indicating a detection value from an orientation sensor that detects values that are usable for the detection of the orientation of the operating surface, such as an acceleration sensor, a gyro sensor, and a geomagnetic sensor.

The information processing apparatus 200 acquires operating surface orientation information by acquiring a detection value detected by the orientation sensor. Herein, an orientation sensor related to the acquisition of operating surface orientation information may be, for example, provided in an apparatus that is provided in an apparatus equipped with a device constituting the operating surface (for example, a pointing device or a touch panel), or an external device to an apparatus equipped with a device constituting the operating surface (for example, an orientation sensor that attaches to the apparatus equipped with a device constituting the operating surface, and is connected to the apparatus equipped with the device constituting the operating surface).

For example, in the case in which the information processing apparatus 200 is an apparatus equipped with a device constituting an operating surface, such as when the operating surface according to the present embodiment is a display screen of a display unit provided in the information processing apparatus 200 (discussed later), the information processing apparatus 200 acquires operating surface orientation information from an equipped orientation sensor or an orientation sensor acting as an external device. As another example, in the case in which the apparatus equipped with the device constituting an operating surface is an external apparatus to the information processing apparatus 200, the information processing apparatus 200 acquires operating surface orientation information by communicating with that external apparatus.

Note that in the case in which the orientation of the operating surface does not vary, such as the case in which an operating surface according to the present embodiment is affixed to a floor, tabletop, or wall, for example, it is possible for the information processing apparatus 200 to conduct a contact region estimation process without using operating surface orientation information, for example. Also, in the above case, the apparatus equipped with the device constituting an operating surface may also not be equipped with an orientation sensor, and in addition, not be connected to an orientation sensor, for example.

As discussed earlier, in the case of estimating a contact region on the side of a device that fulfills the role of a brush from a contact region on the side of an operating surface as in the existing technology, there is a possibility of incorrectly estimating the contact region on the side of the device that fulfills the role of a brush, due to being influenced by the successively varying orientation of the device.

In contrast, by using curvature information and brush apparatus orientation information transmitted from the brush apparatus 100 in a contact region estimation process, for example, it is possible for the information processing apparatus 200 to estimate a curvature magnitude and a tilt magnitude of the tip unit of the brush apparatus 100 with respect to an operating surface.

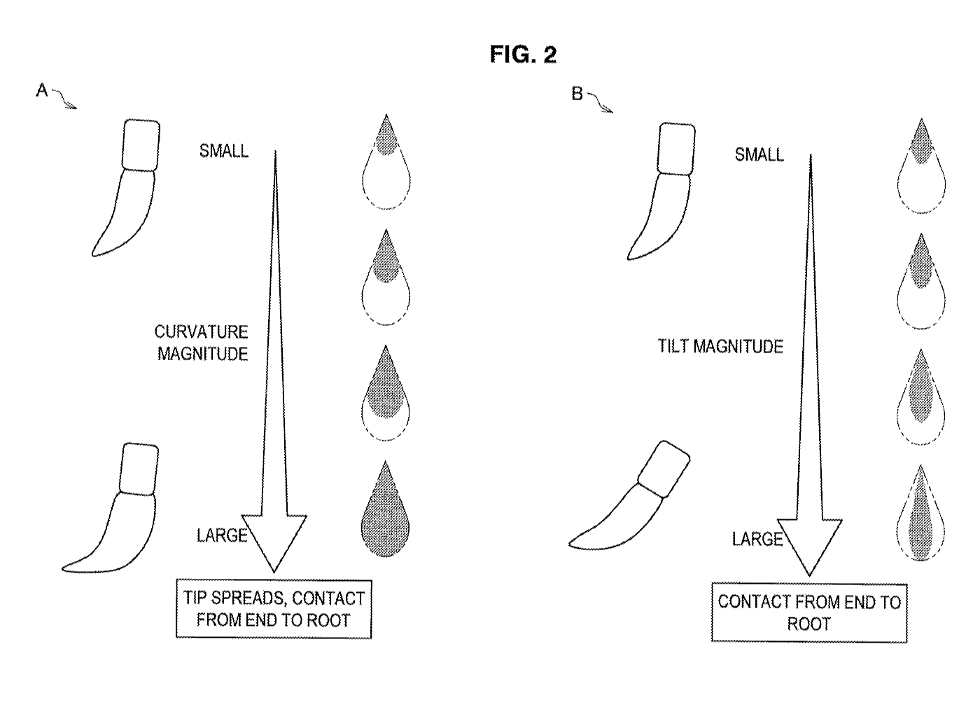

FIG. 2 is an explanatory diagram for describing an example of a process by an information processing apparatus 200 according to the present embodiment. Herein, FIG. 2 schematically illustrates contact region estimation results in a contact region estimation process by the information processing apparatus 200. In FIG. 2, A schematically illustrates an example of contact region estimation results according to the curvature magnitude of the tip unit of the brush apparatus 100 with respect to the operating surface, while B schematically illustrates the tilt magnitude of the tip unit of the brush apparatus 100 with respect to the operating surface.

As illustrated in A and B of FIG. 2, for example, contact region estimation results vary according to the curvature magnitude of the tip unit of the brush apparatus 100 with respect to the operating surface, and the tilt magnitude of the tip unit of the brush apparatus 100 with respect to the operating surface.

As above, it is possible for the information processing apparatus 200 to estimate the curvature magnitude and the tilt magnitude of the tip unit of the brush apparatus 100 with respect to the operating surface. Thus, even if the orientation of the brush apparatus 100 successively varies due to user operations, for example, the information processing apparatus 200 is able to more accurately estimate contact regions on the tip unit of the brush apparatus 100 and the operating surface.

Hereinafter, an example of a contact region estimation process according to the present embodiment will be described more specifically. Hereinafter, a process by the information processing apparatus 200 will be described by primarily taking as an example the case in which the information processing apparatus 200, in a contact region estimation process according to the present embodiment, estimates contact regions on the tip unit of the brush apparatus 100 and the operating surface on the basis of information corresponding to operations on the operating surface transmitted from the brush apparatus 100 (curvature information and brush apparatus orientation information), position information, and operating surface orientation information. Note that in the case in which the orientation of the operating surface does not vary, it is possible for the information processing apparatus 200 to conduct a contact region estimation process according to the present embodiment without using operating surface orientation information, by treating the orientation of the operating surface as a set orientation, for example. Herein, a set orientation of the operating surface may be, for example, a preset orientation, or an orientation that is appropriately set on the basis of a user operation or the like.

The information processing apparatus 200 respectively estimates a contact region on the operating surface and a contact region on the tip unit of the brush apparatus 100, on the basis of curvature information transmitted from the brush apparatus 100 as well a tilt magnitude of the tip unit of the brush apparatus 100 with respect to the operating surface, which is obtained on the basis of brush apparatus orientation information and operating surface orientation information, for example. Herein, the above estimation by the information processing apparatus 200 corresponds to estimating “what part of the tip unit of the brush apparatus 100 is contacting what part of the operating surface (which corresponds to the canvas)”.

### (1-1) Example of Process Related to Estimating Contact Region on Tip Unit of Brush Apparatus 100

First, an example of a process related to estimating a contact region on the tip unit of the brush apparatus 100 will be described.

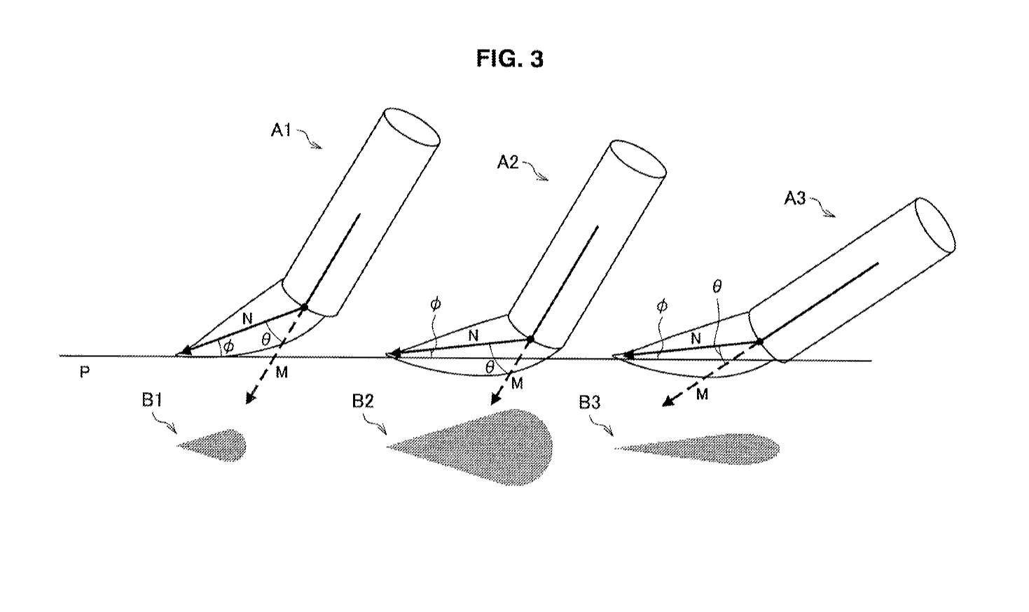

FIG. 3 is an explanatory diagram for describing an example of a process by an information processing apparatus 200 according to the present embodiment, and illustrates an example of a contact region estimation process by the information processing apparatus 200.

Herein, A1 illustrated in FIG. 3 illustrates an example of a state in which the tip unit of the brush apparatus 100 is gently touching the operating surface, whereas A2 illustrated in FIG. 3 illustrates an example of a state in which the tip unit of the brush apparatus 100 is firmly pressed against the operating surface. In addition, A3 illustrated in FIG. 3 illustrates an example of a state in which the brush apparatus 100 is laid flat, and the tip unit of the brush apparatus 100 is gently pressed against the operating surface.

Also, B1 illustrated in FIG. 3 is an example of a point (image) drawn while in the state indicated by A1 in FIG. 3. In other words, B1 illustrates an example of a contact region in the state labeled A1 in FIG. 3. Likewise, B2 and B3 illustrated in FIG. 3 are examples of points (images) drawn while in the states labeled A2 and A3 in FIG. 3, respectively. In other words, B2 and B3 respectively illustrate examples of contact regions in the states labeled A2 and A3 in FIG. 3.

In addition, “θ” illustrated in FIG. 3 indicates the angle obtained between a reference direction M of the brush apparatus 100, and the direction N in which the tip unit is facing. In other words, θ indicates the curvature magnitude of the tip unit of the brush apparatus 100. Also, “φ” illustrated in FIG. 3 indicates the angle obtained between a reference direction P of the operating surface, and the direction N in which the tip unit is facing. In other words, φ indicates the angle of the tip unit of the brush apparatus 100 with respect to the operating surface. Hereinafter, the curvature magnitude of the tip unit of the brush apparatus 100 may be designated the “curvature magnitude θ”, and the angle of the tip unit of the brush apparatus 100 with respect to operating surface may be designated the “angle φ of the tip with respect to the operating surface” in some cases.

For example, compared to the case of the A1 state in FIG. 3 (B1 illustrated in FIG. 3), the shape of the contact region is both longer and wider in the case of the A2 state in FIG. 3 (B2 illustrated in FIG. 3), and the same width but longer in the case of the A3 state in FIG. 3 (B3 illustrated in FIG. 3). Herein, the width of the shape of a contact region according to the present embodiment is the length in the shorter direction of the shape of the contact region (for example, the maximum value of the length in the shorter direction), for example, while the length of the shape of a contact region according to the present embodiment is the length in the longer direction of the shape of the contact region (for example, the maximum value of the length in the longer direction), for example.

Thus, FIG. 3 demonstrates that the width of the shape of a point drawn by contact between the tip unit of the brush apparatus 100 and the operating surface is related to the degree of curvature in the tip unit of the brush apparatus 100, and in addition, that the length of the shape of a point drawn by contact between the tip unit of the brush apparatus 100 and the operating surface is related to the degree of curvature and how far the brush is laid flat.

At this point, examining the state labeled A2 in FIG. 3 demonstrates that the curvature magnitude θ is greater than in the state labeled A1 in FIG. 3, while the angle φ of the tip with respect to the operating surface is less and similar to the state labeled A3 in FIG. 3. Thus, the above may indicate that the reason why the curvature magnitude θ influences the length of the shape of the contact region is because the curvature magnitude θ induces a change in the angle φ of the tip with respect to the operating surface.

In other words, as a result of contact between the tip unit of the brush apparatus 100 and the operating surface, the shape of a point to be drawn by a drawing process discussed later is determined by the curvature magnitude θ and the angle φ of the tip with respect to the operating surface. Also, it may be said that the shape of a point to be drawn by the drawing process discussed later increases in width to the extent that the curvature magnitude θ is large, and increases in length to the extent that the angle φ of the tip with respect to the operating surface is small.

Accordingly, the information processing apparatus 200 computes the curvature magnitude θ on the basis of curvature information, for example.

Additionally, the information processing apparatus 200 computes the angle φ of the tip with respect to the operating surface by using the curvature magnitude θ computed on the basis of the curvature information, as well as brush apparatus orientation information and operating surface orientation information, for example. Note that in the case in which the orientation of the operating surface is set, for example, it is possible for the information processing apparatus 200 to compute the angle φ of the tip with respect to the operating surface by using the curvature magnitude θ and brush apparatus orientation information, for example.

In addition, the information processing apparatus 200 uses the computed curvature magnitude θ to compute the width “w” of the point (image) to be drawn, and in addition, uses the computed angle φ of the tip with respect to the operating surface to compute the length “l” of the point (image) to be drawn, for example.

Hereinafter, an example of a process related to computing a curvature magnitude θ will be described by taking as an example the case in which the curvature information acquired from the brush apparatus 100 is information acquired by a process according to the first example indicated in the above (i) by the brush apparatus 100, or in other words, is information based on an analog magnitude corresponding to the degree of tilt of an analog stick and expressed by a range from 0 to 255.

For example, take “d” to be a value indicating curvature information (a value corresponding to the degree of tilt of an analog stick). In addition, take the d=0 case to indicate the state in which the tip unit of the brush apparatus 100 is maximally curved, take the d=127 case to indicated the state in which the tip unit of the brush apparatus 100 is not curved at all, and take the d=255 case to indicate the state in which the tip unit of the brush apparatus 100 is maximally curved in the opposite direction from d=0.

At this point, if “α” is taken to be the actual curvature magnitude of the tip unit of the brush apparatus 100 when the value of d is “0” or “255”, or in other words, the maximum value (maximum angle) of the curvature magnitude θ, the curvature magnitude θ may be computed by the following Eq. 1, for example.

θ={(d−127)/127}*α (Eq. 1)

Also, if “W” is taken to be the width of the tip of the tip unit in the case in which the curvature magnitude θ is “α”, and if “L” is taken to be the length of the tip of the tip unit in the case in which the curvature magnitude θ is “α”, the width “w” of the point (image) to be drawn is computed by the following Eq. 2.

w=(θ/α)*W (Eq. 2)

In addition, the angle φ of the tip with respect to the operating surface is computed from the angle obtained between the direction N in which the tip unit of the brush apparatus 100 is facing and the reference direction P of the operating surface, by adding a value indicated by brush apparatus orientation information acquired from the brush apparatus 100 to the curvature magnitude θ, for example. Herein, the reference direction P of the operating surface is determined by operating surface orientation information, for example. Note that in the case in which the orientation of the operating surface does not vary, such as the case in which an operating surface according to the present embodiment is affixed to a floor, tabletop, or wall, for example, a reference direction P of the operating surface that corresponds to the set orientation information is set. The set reference direction P of the operating surface may be, for example, a preset reference direction of the operating surface, or a reference direction of the operating surface that is appropriately set by a user operation or the like.

In addition, the length “l” of a point (image) to be drawn is computed by the following Eq. 3, for example.

l=(π/2−φ)*L (Eq. 3)

As above, the information processing apparatus 200 computes a curvature magnitude θ, an angle φ of the tip with respect to the operating surface, a width “w” of the point (image) to be drawn, and a length “l” of the point (image) to be drawn, for example. By computing the curvature magnitude θ, the angle φ of the tip with respect to the operating surface, the width “w” of the point (image) to be drawn, and the length “l” of the point (image) to be drawn, the shape of the contact region on the tip unit of the brush apparatus 100 is estimated.

Herein, the values of the above “α”, “W”, and “L” related to estimating a contact region on the tip unit of the brush apparatus 100 are determined according to factors such as the shape and material of the tip unit provided in the brush apparatus 100. The information processing apparatus 200 uses values of the above “α”, “W”, and “L” corresponding to the brush apparatus 100 that are being stored in a storage unit (discussed later) or an external recording medium, or uses values of the above “α”, “W”, and “L” acquired from the brush apparatus 100.

When the shape of a contact region on the tip unit of the brush apparatus 100 is estimated, the information processing apparatus 200 estimates the contact region on the tip unit of the brush apparatus 100 by estimating which position of the tip unit of the brush apparatus 100 matches, for example.

More specifically, the information processing apparatus 200 estimates the contact region on the tip unit of the brush apparatus 100 on the basis of a contactable region and the estimated shape of a contact region on the tip unit of the brush apparatus 100, for example.

Herein a contactable region according to the present embodiment refers to the largest region on the operating surface from among regions that the tip unit of the brush apparatus 100 is capable of contacting. More specifically, a contactable region according to the present embodiment may be, for example, a region in the case in which the curvature magnitude θ is the maximum value (maximum angle) α, or in other words, the largest region on the operating surface that the tip unit of the brush apparatus 100 is capable of contacting at one time. Also, in a color management process according to the present embodiment discussed later, in the case of using a region that corresponds to a change in the contactable region on the tip unit of the brush apparatus 100 due to rotation of the brush apparatus 100 (the fan-shaped region discussed later), for example, the information processing apparatus 200 uses brush apparatus orientation information to compute a contactable region according to the present embodiment, for example.

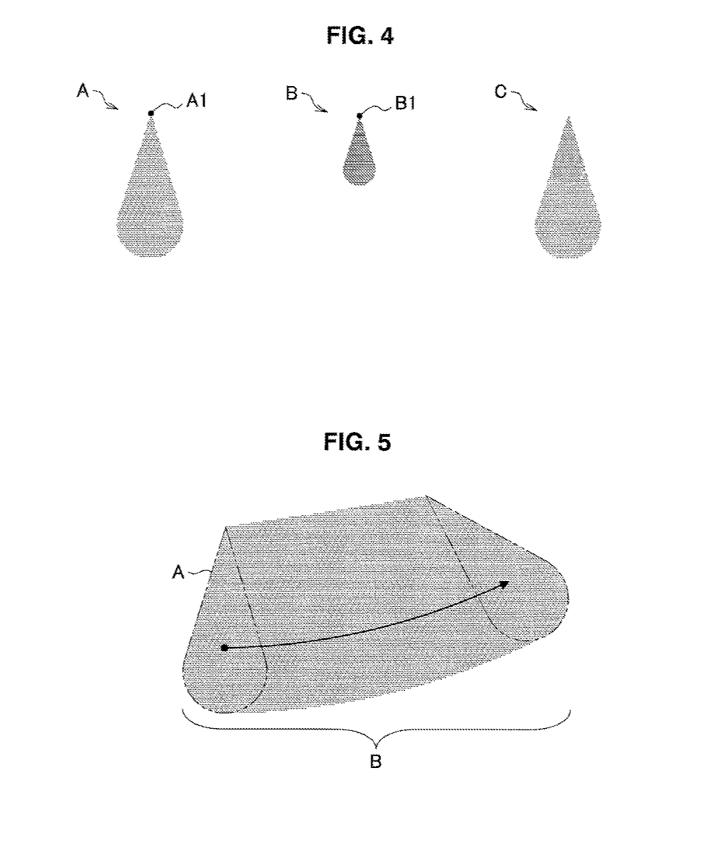

FIG. 4 is an explanatory diagram for describing an example of a process by an information processing apparatus 200 according to the present embodiment. Herein, FIG. 4 illustrates an overview of a process related to estimating a contact region on the tip unit of the brush apparatus 100 by the information processing apparatus 200. In FIG. 4, A illustrates an example of a contactable region, while B illustrates an example of an estimated shape of a contact region on the tip unit of the brush apparatus 100. Also, in FIG. 4, C illustrates an overview of a process related to estimating a contact region on the tip unit of the brush apparatus 100 by the information processing apparatus 200.

Imagining an actual brush, it is possible to draw thin lines in which just the end of the brush makes contact, and also thick lines in which the brush makes contact from end to root. Also, a brush basically makes contact successively, starting at the tip and going towards the root.

In addition, in the case in which the contactable area is the largest area on the operating surface that the tip unit of the brush apparatus 100 is capable of contacting at one time, for example, the estimated shape of the contact region on the tip unit of the brush apparatus 100 becomes a region corresponding to some portion of the contactable region (in other words, a region included in the contactable region).

Consequently, as illustrated in C of FIG. 4, for example, the information processing apparatus 200 overlays the contactable region and the estimated shape of the contact on the tip unit of the brush apparatus 100, so that the position corresponding to the end of the tip in the contactable region illustrated in A of FIG. 4 (labeled A1 in A of FIG. 4) is the same as the position corresponding to the end of the tip in the estimated shape of the contact region on the tip unit of the brush apparatus 100 illustrated in B of FIG. 4 (labeled B1 in B of FIG. 4). As illustrated in C of FIG. 4, for example, by overlaying the contactable region and the estimated shape of the contact region on the tip unit of the brush apparatus 100, the information processing apparatus 200 is able to compute which portion of the contactable region matches the estimated shape of the contact region on the tip unit of the brush apparatus 100.

Herein, the information processing apparatus 200 uses data indicating a contactable region related to estimating a contact region on the tip unit of the brush apparatus 100, which is stored in a storage unit (discussed later) or an external recording medium, for example.

As above, for example, the information processing apparatus 200 estimates a contact region on the tip unit of the brush apparatus 100 by computing which portion of the contactable region matches the estimated shape of the contact region on the tip unit of the brush apparatus 100.

### (1-2) Example of Process Related to Estimating Contact Region on Operating Surface

Next, an example of a process related to estimating a contact region on the operating surface will be described.

For example, the information processing apparatus 200 estimates a contact region on the operating surface by applying a contact region on the tip unit of the brush apparatus 100 estimated by the process in the above (1-1) to a contact position of the tip unit of the brush apparatus 100 on the operating surface as indicated by position information, according to the tip facing, which is based on brush apparatus orientation information.

As a contact region estimation process according to the present embodiment, the information processing apparatus 200 estimates contact regions on the tip unit of the brush apparatus 100 and the operating surface by conducting the process of the above (1-1) and the process of the above (1-2), for example.

Note that a contact region estimation process according to the present embodiment by the information processing apparatus 200 is not limited to the process of the above (1-1) and the process of the above (1-2). For example, the information processing apparatus 200 may also estimate a contact region by using a projected image of the tip onto the operating surface, based on acquired brush apparatus orientation information. Other examples of a contact region estimation process according to the present embodiment will be discussed later.

### (2) Drawing Process

When contact regions on the tip unit of the brush apparatus 100 and the operating surface are estimated by the process of the above (1) (contact region estimation process), the information processing apparatus 200, on the basis of the contact region estimation result, causes drawing according to operations on the operating surface by the brush apparatus 100 to be conducted on a display screen. For example, the information processing apparatus 200 causes drawing according to operations on the operating surface by the brush apparatus 100 to be conducted in a region (hereinafter designated the “corresponding region”) of a display screen that corresponds to a contact region on the operating surface estimated by the process of the above (1) (contact region estimation process).

Herein, a display screen on which the information processing apparatus 200 conducts drawing according to operations may be, for example, a display screen of a display unit provided in the information processing apparatus 200 (discussed later). Note that the display screen on which the information processing apparatus 200 conducts drawing according to operations is not limited to the above. For example, the display screen on which the information processing apparatus 200 conducts drawing according to operations may also be a display screen of a display device provided in an external apparatus to the information processing apparatus 200.

Also, the display screen on which the information processing apparatus 200 conducts drawing according to operations may be the same as, or different from, an operating surface according to the present embodiment. For example, in the case in which the display screen on which the information processing apparatus 200 conducts drawing according to operations is the same as an operating surface according to the present embodiment, the result of the information processing apparatus 200 drawing in a corresponding region on the display screen, such as a letter or picture that a user draws on the operating surface using the brush apparatus 100, for example, is drawn at the position contacted by the tip unit of the brush apparatus 100 on that operating surface.

FIG. 5 is an explanatory diagram for describing an example of a process by an information processing apparatus 200 according to the present embodiment. Herein, FIG. 5 illustrates an example of a drawing algorithm in a drawing process by the information processing apparatus 200.

The information processing apparatus 200 draws the estimated shape of a contact region on the operating surface (for example, the shape labeled A in FIG. 5) each time a contact region on the operating surface is estimated. Herein, the estimated shape of a contact region on the operating surface as illustrated in A of FIG. 5 corresponds to the shape that appears on a drawing surface such as a canvas when a brush makes contact with that canvas (what may be called the “footprint”). Consequently, as a result of the information processing apparatus 200 conducting a process like the above in the drawing process, a shape expressed by a set of estimated shapes of a contact region on the operating surface as illustrated in A of FIG. 5 (or in other words, a shape made by a stroke) is drawn on a display screen, as illustrated in B of FIG. 5, for example.

The information processing device 200, using a drawing algorithm like that illustrated in FIG. 5, for example, causes drawing according to operations performed on an operating surface by the brush apparatus 100 to be conducted on a display screen.

Note that a drawing algorithm in a drawing process according to the present embodiment is not limited to the example illustrated in FIG. 5.

For example, in the case in which the size of a region made up of a set of estimated shapes of a contact region on the operating surface like that illustrated in B of FIG. 5 for example becomes equal to or greater than a set threshold (or alternatively, in the case of becoming greater than a set threshold), it is also possible for the information processing apparatus 200 to not draw some of the estimated shape of a contact region on the operating surface. As a result of the information processing apparatus 200 conducting a process like the above for example in a drawing process according to the present embodiment, it becomes possible for a user to use the brush apparatus 100 to realize the expression of kasure (white streaks in a letter or drawing as a result of drawing with small quantities of ink or paint). Herein, the above threshold used in a process related to the above kasure expression may be a preset, fixed value, or a value that may be appropriately set or modified by the user.

In addition, on the basis of curvature information acquired from the brush apparatus 100, the information processing apparatus 200 may also detect an upward flick of the tip unit of the brush apparatus 100, and draw an upward flick on the display screen in the case of detecting an upward flick.

Herein, it is possible for the information processing apparatus 200 to monitor the curvature state of the tip unit of the brush apparatus 100 from curvature information acquired from the brush apparatus 100, for example. Additionally, by detecting sudden reductions in curvature magnitude of the tip unit of the brush apparatus 100 (an example of a change in the curvature state), for example, the information processing apparatus 200 is able to detect upward flicks of the tip unit of the brush apparatus 100. More specifically, in the case in which the amount of change in the curvature magnitude over a set period is less than or equal to a set threshold (or alternatively, in the case of being less than a set threshold), for example, the information processing apparatus 200 decides that an upward flick in the tip unit of the brush apparatus 100 has been detected.

Also, when imagining an actual brush, an upward flick in the tip is an extremely short period of reduction. For this reason, real-time performance is demanded when attempting to draw upward flicks of the tip, and realization is difficult in the case of conducting an intensive process with an extremely heavy computational load, such as a 3D profile simulation of the tip, for example. In addition, it is difficult to reproduce upward flicks of the tip when there is a possibility of incorrectly estimating the contact region on the side of the device that fulfills the role of a brush, as with the existing technology, for example.

In contrast, since the information processing apparatus 200 is capable of detecting upward flicks in the tip unit of the brush apparatus 100 on the basis of curvature information acquired from the brush apparatus 100, the information processing apparatus 200 is able to draw upward flicks on a display screen using a non-intensive process with a lighter computational load.

Consequently, the information processing apparatus 200 is able to selectively drawn upward flicks on a display screen on the basis of curvature information acquired from the brush apparatus 100. Also, the information processing apparatus 200 is able to draw upward flicks on a display screen while satisfying the demand for real-time performance. Furthermore, by drawing upward flicks on a display screen, the information processing apparatus 200 is able to realize drawing with the dynamic lines that are characteristic of brushes.

Note that a drawing process according to the present embodiment is not limited to the above.

### (a) First Example of Drawing Process According to Present Embodiment

For example, as a drawing process according to the present embodiment, the information processing apparatus 200 may also simulate the transfer of virtual paint between the tip unit of the brush apparatus 100 and a corresponding region on a display screen. In the case of simulating the transfer of virtual paint, the information processing apparatus 200 causes drawing based on simulation results to be conducted on a display screen.

For example, the information processing apparatus 200 simulates the transfer of virtual paint between the tip unit of the brush apparatus 100 and a corresponding region on a display screen by using information related to the shape of the tip unit of the brush apparatus 100 stored in a storage unit (discussed later) or an external recording medium, or alternatively, information related to the shape of the tip unit of the brush apparatus 100 acquired from the brush apparatus 100.

Herein, information related to the shape of the tip unit of the brush apparatus 100 according to the present embodiment may be, for example, data indicating the width “W” of the tip of the tip unit, and data indicating the length “L” of the tip of the tip unit. Additionally, information related to the shape of the tip unit of the brush apparatus 100 according to the present embodiment may also include data indicating a brush type.

Also, virtual paint according to the present embodiment may be, for example, data on respective colors constituting a color palette that virtually realizes coloration by dyes, pigments, or inks, for example.

Transfer of virtual paint simulated by the information processing apparatus 200 according to the present embodiment may be, for example, the transfer of virtual paint from the tip unit of the brush apparatus 100 to a corresponding region on a display screen. As a result of the information processing apparatus 200 simulating the transfer of virtual paint from the tip unit of the brush apparatus 100 to a corresponding region on a display screen, color corresponding to a virtual paint applied to the tip unit of the brush apparatus 100 by the user is drawn in the corresponding region of the display screen, for example.

Herein, as discussed earlier, the information processing apparatus 200 is able to estimate which portion of a contactable region matches a contact region on the tip unit of the brush apparatus 100 by conducting the process of the above (1) (contact region estimation process), for example. Thus, it is possible for the information processing apparatus 200 to simulate the transfer of virtual paint from the tip unit of the brush apparatus 100 to a corresponding region on a display screen for each estimated contact region on the tip unit of the brush apparatus 100.

Consequently, by simulating the transfer of virtual paint, the information processing apparatus 200 is able to realize advanced expression such as uneven color.

Note that transfer of virtual paint simulated by the information processing apparatus 200 according to the present embodiment is not limited to the above. For example, the information processing apparatus 200 may also simulate both the transfer of virtual paint from the tip unit of the brush apparatus 100 to a corresponding region on a display screen, and the transfer of virtual paint from that corresponding region to the tip unit of the brush apparatus 100.

By having the information processing apparatus 200 simulate the transfer of virtual paint from the tip unit of the brush apparatus 100 to a corresponding region on a display screen, and furthermore simulate the transfer of virtual paint from that corresponding region to the tip unit of the brush apparatus 100, the information processing apparatus 200 is able to realize even more advanced expression.

### (b) Second Example of Drawing Process According to Present Embodiment

In the case in which the information processing apparatus 200 simulates the transfer of virtual paint from a corresponding region on a display screen to the tip unit of the brush apparatus 100, when the tip unit of the brush apparatus 100 includes a color change mechanism capable of changing color, the information processing apparatus 200 may also control the change of color in the tip unit of the brush apparatus 100 on the basis of that simulation result. For example, the information processing apparatus 200 controls the change in color in the tip unit of the brush apparatus 100 by transmitting a control signal controlling change in color to the brush apparatus 100 via a communication unit (discussed later), or alternatively, a connected external communication device.

Herein, a control signal controlling change in color according to the present embodiment may be, for example, a signal that indicates a position of the tip unit of the brush apparatus 100, and the color of virtual paint to transfer from the corresponding region on the display screen to the tip unit of the brush apparatus 100 at that position. Also, a control signal controlling change in color according to the present embodiment may be a signal in a format corresponding to the color change mechanism included in the tip unit of the brush apparatus 100.

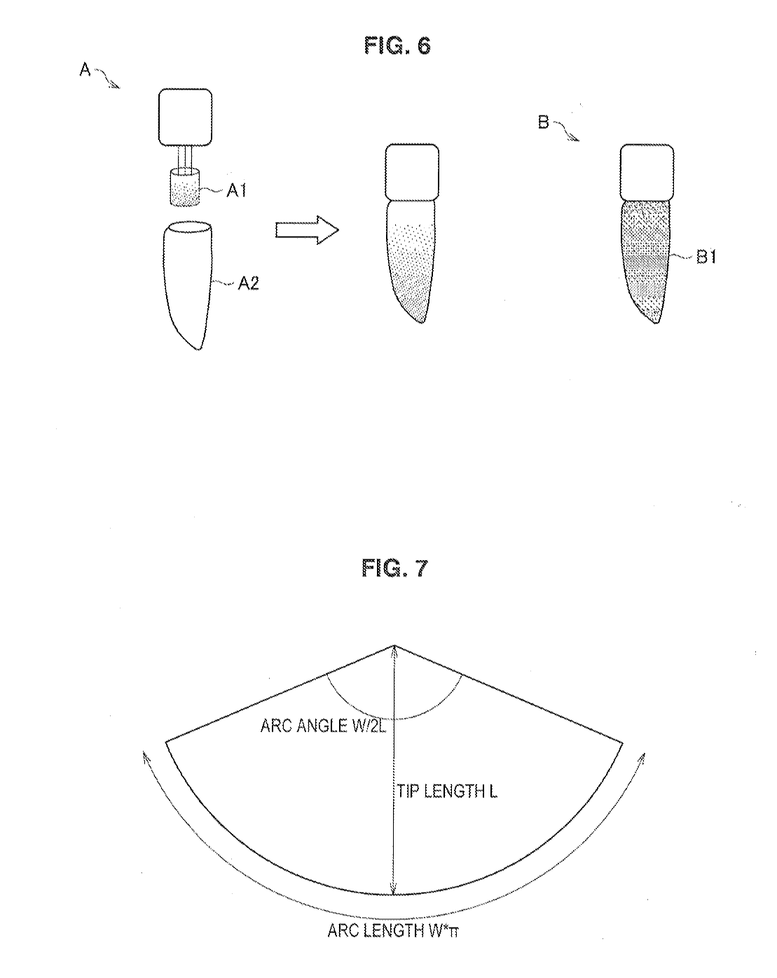

FIG. 6 is an explanatory diagram for describing an example of a process by the information processing apparatus 200, and illustrates an example of a color change mechanism included in the tip unit of a brush apparatus 100 according to the present embodiment.

In FIG. 6, A illustrates a first example of a color change mechanism included in the tip unit of the brush apparatus 100. The color change mechanism according to the first example includes a light-emitting element (labeled A1 in A of FIG. 6), and a cap (labeled A2 in A of FIG. 6) that covers the light-emitting element.

Herein, although A of FIG. 6 illustrates an example in which the color change mechanism according to the first example is made up of a single light-emitting element, the color change mechanism according to the first example is not limited to the above. For example, the color change mechanism according to the first example may also be made up of multiple light-emitting elements. A light-emitting element included in the color change mechanism according to the first example may be, for example, a full-color light-emitting diode (LED) or the like.

In the case in which the tip unit of the brush apparatus 100 includes the color change mechanism according to the first example illustrated in A of FIG. 6, for example, the information processing apparatus 200 controls change in color in the tip unit of the brush apparatus 100 by transmitting to the brush apparatus 100 a control signal controlling electrical conduction to the light-emitting element, for example.

Also, in FIG. 6, B illustrates a second example of a color change mechanism included in the tip unit of the brush apparatus 100. The color change mechanism according to the second example is made up of a material that changes color according to an applied voltage, for example. Herein, a material that changes color according to an applied voltage according to the present embodiment may be, for example, a material using a polymer material such as polystyrene.

In the case in which the tip unit of the brush apparatus 100 includes the color change mechanism according to the second example illustrated in B of FIG. 6, for example, the information processing apparatus 200 controls change in color in the tip unit of the brush apparatus 100 by transmitting to the brush apparatus 100 a control signal controlling a voltage applied to the color change mechanism according to the second example, for example.

### (c) Third Example of Drawing Process According to Present Embodiment

When imagining an actual brush, drawing with an actual brush has a tactile sensation of friction between tip and canvas. Also, the above tactile sensation may successively vary according to factors such as the thickness of the paint and degree of kasure, for example.

For example, in order to make the user of the brush apparatus 100 feel a tactile sensation like the above, in the information processing system 1000, the brush apparatus 100 may be equipped with a feedback unit that produces tactile feedback for the user in response to operations on the operating surface, for example. In the case in which the brush apparatus 100 is equipped with a feedback unit, the information processing apparatus 200 controls tactile feedback by the feedback unit of the brush apparatus 100 on the basis of estimation results for contact regions on the tip unit of the brush apparatus 100 and the operating surface.

Herein, the feedback unit provided in the brush apparatus 100 includes an actuator, for example. The information processing apparatus 200 controls tactile feedback by the feedback unit of the brush apparatus 100 by transmitting a control signal causing the actuator (an example of a device constituting a feedback unit) to operate to the brush apparatus 100 via a communication unit (discussed later), or alternatively, a connected external communication device, for example. Note that the feedback unit provided in the brush apparatus 100 is not limited to including an actuator, and may have an arbitrary configuration capable of producing tactile feedback for the user, for example.

For example, the information processing apparatus 200 transmits a control signal corresponding to an estimated contact region to the brush apparatus 100 on the basis of factors such as the sizes of estimated contact regions on the tip unit of the brush apparatus 100 and the operating surface, and the shapes of those contact regions (for example, see B1 to B3 illustrated in FIG. 3 and the like). Herein, the information processing apparatus 200 determines a control signal corresponding to an estimated contact region by referencing a table or the like in which region sizes and shapes are associated with types of control signals, for example, and then transmits a control signal to the brush apparatus 100.

Note that the method of transmitting a control signal corresponding to an estimated contact region by the information processing apparatus 200 is not limited to the above.

For example, when imagining an actual brush, there are various types of drawing, such as “watercolor painting”, “oil painting”, and “ink painting”. In the information processing system 1000, respective types of drawing like the above may be treated as drawing modes, for example, and the information processing apparatus 200 may additionally control tactile feedback by the feedback unit of the brush apparatus 100 on the basis of the set drawing mode. Herein, a drawing mode according to the present embodiment may be preset, or appropriately set with a user operation or the like, for example.

For example, by changing the table or the like related to determining a control signal corresponding to an estimated contact region according to the set drawing mode, the information processing apparatus 200 transmits to the brush apparatus 100 a control signal corresponding to the set drawing mode as well as the estimated contact region.

As another example, in the case in which virtual paint associated with the tip unit of the brush apparatus 100 and virtual paint associated with a corresponding region on a display screen are managed by a color management process according to the present embodiment to be discussed later, the information processing apparatus 200 may additionally adjust a control signal corresponding to an estimated contact region on the basis of the combination of virtual paints respectively associated with the tip unit of the brush apparatus 100 and the corresponding region.

As above, for example, by having the information processing apparatus 200 transmit to the brush apparatus 100 a control signal corresponding to an estimated contact region (a control signal based on a contact region estimation result), there is realized in the information processing system 1000 a tactile sensation of friction between tip and canvas, and a tactile sensation corresponding to virtual paints associated with each corresponding region given to the user.

### (d) Fourth Example of Drawing Process According to Present Embodiment

The information processing apparatus 200 may also cause drawing corresponding to a set drawing mode to be conducted on a display screen. For example, the information processing apparatus 200 causes drawing corresponding to a set drawing mode to be conducted on a display screen by using arbitrary technology capable of simulating a drawing environment corresponding to the set drawing mode, such as an arbitrary technology capable of simulating a drawing environment corresponding to “watercolor painting”, an arbitrary technology capable of simulating a drawing environment corresponding to “oil painting”, and an arbitrary technology capable of simulating a drawing environment corresponding to “ink painting”.

### (e) Fifth Example of Drawing Process According to Present Embodiment

The information processing apparatus 200 may also cause the shape of a contact region estimated by the process in the above (1) (contact region estimation process), or a color distribution within that contact region, for example, to be displayed on the display screen being drawn upon, or on a display screen of another display device. In addition, the information processing apparatus 200 may jointly display which portion of the above estimated contact region is being used to draw. By presenting a display like the above, for example, the information processing apparatus 200 is able to realize drawing assistance for the user.

The information processing device 200 causes drawing according to operations performed on an operating surface by the brush apparatus 100 to be presented on a display screen by conducting the process in the above (1) (contact region estimation process) and the process in the above (2) (drawing process), for example.

Herein, in the process in the above (1) (contact region estimation process), the information processing apparatus 200 estimates a curvature magnitude and a tilt magnitude of the tip unit of the brush apparatus 100 with respect to the operating surface, and estimates contact regions on the tip unit of the brush apparatus 100 and the operating surface. Thus, even if the orientation of the brush apparatus 100 successively varies due to user operations, for example, the information processing apparatus 200 is able to more accurately estimate contact regions on the tip unit of the brush apparatus 100 and the operating surface. Additionally, in the process in the above (2) (drawing process), the information processing apparatus 200 causes drawing according to operations on an operating surface by the brush apparatus 100 to be conducted on a display screen on the basis of contact region estimation results.

Consequently, by conducting the process in the above (1) (contact region estimation process) and the process in the above (2) (drawing process), the information processing apparatus 200 is able to realize drawing as though actually drawn with a brush.

Note that processes by the information processing apparatus 200 according to the present embodiment are not limited to the process in the above (1) (contact region estimation process) and the process in the above (2) (drawing process).

### (3) Color Management Process

For example, the information processing apparatus 200 may also manage virtual paint associated with the tip unit of the brush apparatus 100, and virtual paint associated with a corresponding region on a display screen (a color management process).

For example, the information processing apparatus 200 manages virtual paint associated with the tip unit of the brush apparatus 100 at the respective coordinates of each position in a contactable region according to the present embodiment as illustrated in A of FIG. 4, for example. Herein, managing virtual paint at the respective coordinates of each position in a contactable region corresponds to managing virtual paint in contact region units on the tip unit of the brush apparatus 100 when the tip unit of the brush apparatus 100 contacts the operating surface, for example.

Note that a color management process according to the present embodiment is not limited to managing virtual paint at the respective coordinates of each position in a contactable region.

As above, managing virtual paint at the respective coordinates of each position in a contactable region corresponds to managing virtual paint in contact region units on the tip unit of the brush apparatus 100, for example. In other words, in the case of managing virtual paint at the respective coordinates of each position in a contactable region, the information processing apparatus 200 does not manage virtual paint in correspondence with the entire surface of the tip unit of the brush apparatus 100.

Consequently, in a color management process according to the present embodiment, the information processing apparatus 200 may also manage virtual paint in correspondence with the entire surface of the tip unit of the brush apparatus 100.

More specifically, the information processing apparatus 200 manages virtual paint associated with the tip unit of the brush apparatus 100 at the respective coordinates of each position in a region on the tip unit of the brush apparatus 100 that corresponds to change in the contactable region due to rotation of the brush apparatus 100 (the fan-shaped region discussed later), for example.

FIGS. 7 to 9 are explanatory diagrams for describing an example of a color management process by an information processing apparatus 200 according to the present embodiment.

When considering rotation of the axis of the brush apparatus 100 (the axis corresponding to the reference direction M of the brush apparatus 100 illustrated in FIG. 3, for example), the region corresponding to change in the contactable region due to rotation of the brush apparatus 100 becomes a fan-shaped region defined by the width “W” of the tip and the length “L” of the tip of the tip unit of the brush apparatus 100, as illustrated in FIG. 7, for example.

Consequently, as a result of the information processing apparatus 200 managing virtual paint at the respective coordinates of each position in a fan-shaped region like that illustrated in FIG. 7, for example, it becomes possible to manage virtual paint associated with the tip unit of the brush apparatus 100 at each position on the entire surface of the tip unit of the brush apparatus 100.

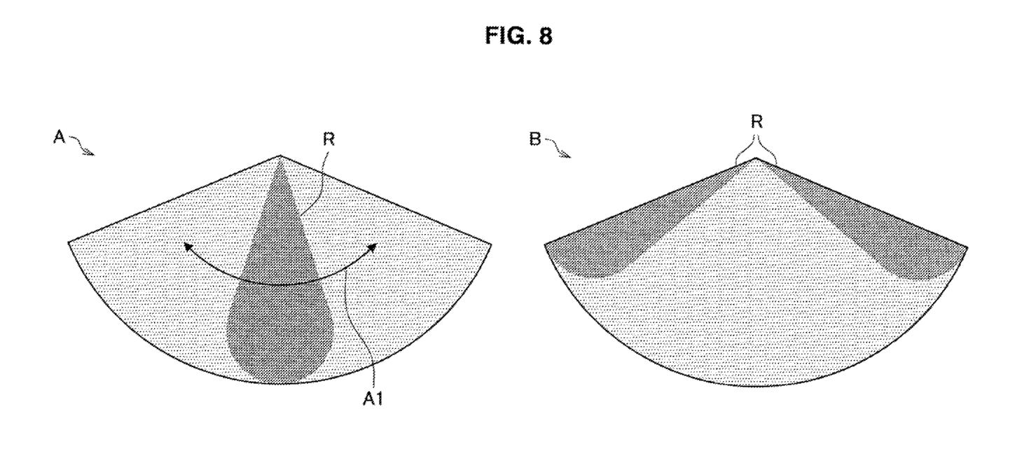

In the case in which the information processing apparatus 200 manages virtual paint at the respective coordinates of each position in a fan-shaped region like that illustrated in FIG. 7, for example, the information processing apparatus 200 extracts a contactable region from the fan-shaped region on the basis of a rotational magnitude of the brush apparatus 100, as illustrated by R in each of A and B of FIG. 8, for example. Herein, the contactable region extracted from the fan-shaped region varies according to rotation of the axis of the brush apparatus 100, as indicated by A1 in A of FIG. 8, for example, with the edges of the fan-shaped region looping around, as indicated in B of FIG. 8, for example.

Herein, the information processing apparatus 200 specifies a rotational magnitude of the brush apparatus 100 on the basis of information indicating a rotational magnitude of the brush apparatus 100 included in brush apparatus orientation information acquired from the brush apparatus 100, for example.

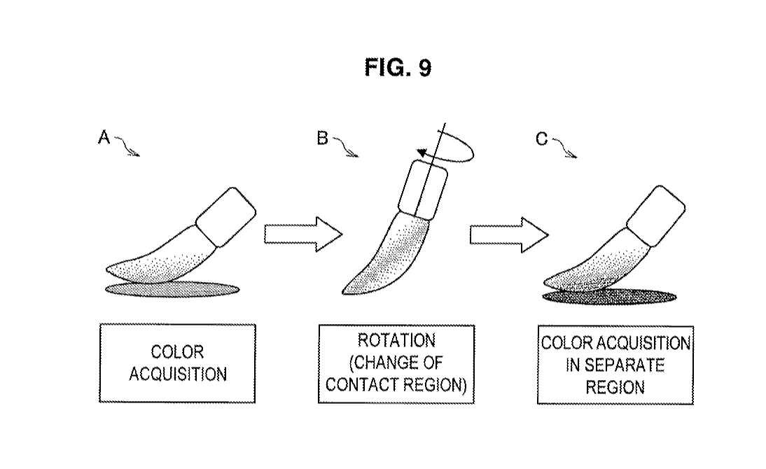

By managing virtual paint at the respective coordinates of each position in a fan-shaped region like that illustrated in FIG. 7, for example, it becomes possible for the information processing apparatus 200 to manage virtual paint corresponding to respective regions of the tip unit of the brush apparatus 100, such as regions corresponding to the sides or a region corresponding to the back of the tip unit of the brush apparatus 100, even in cases in which the axis of the brush apparatus 100 has rotated. Consequently, since the information processing apparatus 200 is capable of managing virtual paint corresponding to the tip unit of the brush apparatus 100 in three dimensions, the transfer of virtual paint at each of respective regions corresponding to the surface of the tip unit of the brush apparatus 100 may be realized, as illustrated in A, B, and C of FIG. 9.

The information processing apparatus 200 manages virtual paint associated with the tip unit of the brush apparatus 100 by associating colors with the coordinates of respective positions in a contactable region in a table, database, or the like, for example. Also, the information processing apparatus 200 may additionally associate quantities of virtual paint, for example.

In addition, the information processing apparatus 200 manages virtual paint associated with a corresponding region on a display screen by associating colors with the coordinates of respective positions in a region corresponding to the display screen in a table, database, or the like, for example. Also, the information processing apparatus 200 may additionally associate quantities of virtual paint, for example.

Herein, in the case of simulating the transfer of virtual paint, the information processing apparatus 200 respectively overwrites and updates the virtual paint associated with the tip unit of the brush apparatus 100 onto which virtual paint transferred, and the virtual paint associated with a corresponding region on a display screen onto which virtual paint transferred.

Note that a color management process according to the present embodiment is not limited to the above.

For example, in the case of simulating the transfer of virtual paint, the information processing apparatus 200 may conduct “color mixing between virtual paint associated with the tip unit of the brush apparatus 100 and virtual paint transferred from a corresponding region” and/or “color mixing between virtual paint associated with a corresponding region on a display screen and virtual paint transferred from the tip unit of the brush apparatus 100”.

In the case of conducting a process related to color mixing in a color management process according to the present embodiment, the information processing apparatus 200 mixes the color of transferred virtual paint with the color of virtual paint at the transfer site to which virtual paint transfers, for example. Subsequently, the information processing apparatus 200 overwrites and updates the virtual paint associated with the tip unit of the brush apparatus 100 onto which virtual paint transferred, and/or the virtual paint associated with a corresponding region on a display screen onto which virtual paint transferred, with the mixed virtual paint.

By conducting a color management process according to the present embodiment as above, for example, the information processing apparatus 200 respectively manages virtual paint associated with the tip unit of the brush apparatus 100, and virtual paint associated with a corresponding region on a display screen.

At this point, an example of the advantages of having the information processing apparatus 200 conduct a color management process according to the present embodiment will be described.

As above, as a result of the information processing apparatus 200 conducting a color management process according to the present embodiment, it is possible to manage which colors of virtual paint are associated with which portions of the tip unit of the brush apparatus 100. Additionally, in the process in the above (1) (contact region estimation process), it is possible for the information processing apparatus 200 to respectively estimate a contact region on the operating surface and a contact region on the tip unit of the brush apparatus 100.

Consequently, in the process in the above (2) (drawing process), the information processing apparatus 200 is able to determine what color of virtual paint is transferring from a contact region on the tip unit of the brush apparatus 100 to a corresponding region on a display screen that corresponds to the contact region on the operating surface. Also, in the case in which virtual paint is already associated with a corresponding region on a display screen that corresponds to the contact region on the operating surface, in the process in the above (2) (drawing process), the information processing apparatus 200 is able to determine what color of virtual paint is transferring from the contact region on the operating surface that corresponds to that corresponding region to the contact region on the tip unit of the brush apparatus 100.

Consequently, by conducting a color management process according to the present embodiment, the information processing apparatus 200 is able to more closely simulate “the transfer of virtual paint from a contact region on the tip unit of the brush apparatus 100 to a corresponding region on a display screen that corresponds to a contact region on the operating surface” and “the transfer of virtual paint from a contact region on the operating surface that corresponds to that corresponding region to a contact region on the tip unit of the brush apparatus 100”. Also, by additionally conducting a process related to color mixing in the process in the above (2) (drawing process), the information processing apparatus 200 is able to more closely simulate the above transfer of virtual paint.

In the information processing system 1000, the brush apparatus 100, by conducting the process indicated in the above section [1-1], for example, transmits information corresponding to user operations on the operating surface (for example, curvature information and brush apparatus orientation information) to the information processing apparatus 200 via a communication unit (discussed later) or an external communication device. Also, in the information processing system 1000, the information processing apparatus 200, by conducting the process indicated in the above section [1-2], for example, causes drawing according to operations performed on the operating surface by the brush apparatus 100 to be conducted on a display screen.

Herein, in the process in the above (1) (contact region estimation process), the information processing apparatus 200 estimates contact regions on the tip unit of the brush apparatus 100 and the operating surface, on the basis of curvature information and brush apparatus orientation information transmitted from the brush apparatus 100, and position information, for example. In addition, in the process in the above (1) (contact region estimation process), it is also possible for the information processing device 200 to estimate contact regions on the tip unit of the brush apparatus 100 and the operating surface on the additional basis of operating surface orientation information, for example. Thus, even if the orientation of the brush apparatus 100 successively varies due to user operations, for example, the information processing apparatus 200 is able to more accurately estimate contact regions on the tip unit of the brush apparatus 100 and the operating surface. Additionally, in the process in the above (2) (drawing process), the information processing apparatus 200 causes drawing according to operations on an operating surface by the brush apparatus 100 to be conducted on a display screen on the basis of contact region estimation results.

Consequently, as a result of the information processing apparatus 200 conducting the process in the above (1) (contact region estimation process) and the process in the above (2) (drawing process), there is realized an information processing system capable of realizing drawing as though actually drawn with a brush.

Example of process by information processing system according to present embodiment

Next, an example of a process by an information processing system 1000 according to the present embodiment discussed above will be given.

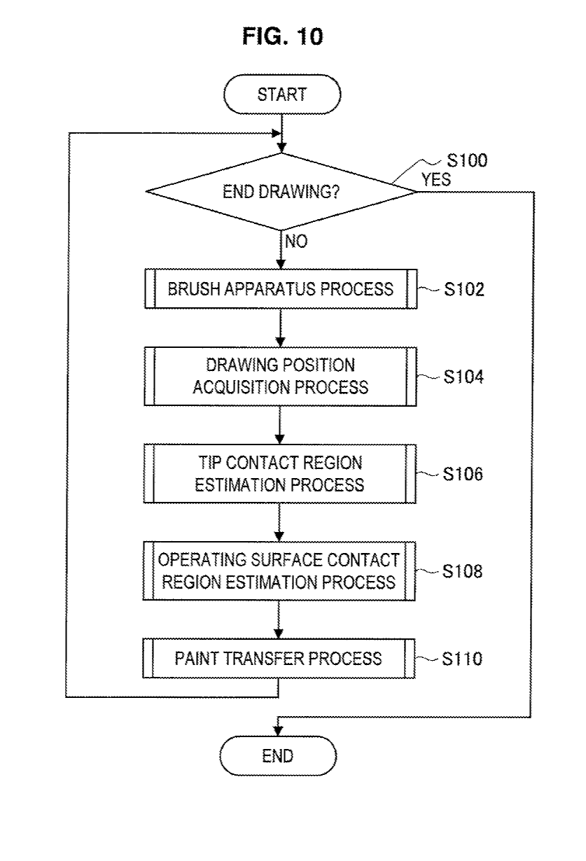

FIG. 10 is a flowchart for describing an example of a process by an information processing system 1000 according to the present embodiment. Herein, the processes in step S100 and steps S104 to S110 illustrated in FIG. 10 correspond to processes by the information processing apparatus 200. Also, the process in step S102 illustrated in FIG. 10 corresponds to a process by the brush apparatus 100.

The information processing apparatus 200 determines whether or not to end drawing (S100). The information processing apparatus 200 determines to end drawing in the case in which an application related to drawing ends as a result of an operation by the user of the brush apparatus 100 or the user of the information processing apparatus 200, for example.

In the case of determining to end drawing in step S100, the information processing apparatus 200 ends the process, and as a result, the process by the information processing system 1000 also ends.

Meanwhile, in the case of not determining to end drawing in step S100, a process by the brush apparatus 100 is conducted in the information processing system 1000 (S102).

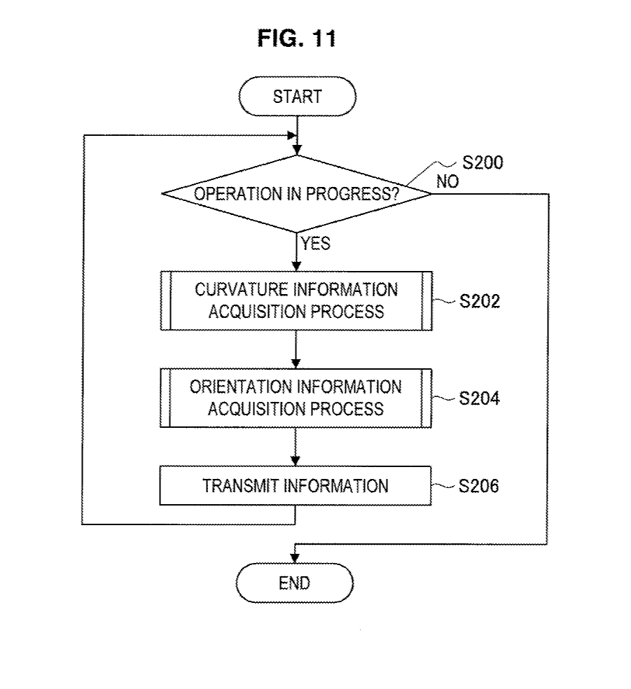

FIG. 11 is a flowchart for describing an example of a process by an information processing system 1000 according to the present embodiment, and illustrates an example of a process by the brush apparatus 100.

The brush apparatus 100 determines whether or not operation is in progress (S200). The brush apparatus 100 determines that operation is in progress in the case in which the power is on or an operating switch is on, for example.

In the case of not determining that operation is in progress in step S200, the brush apparatus 100 does not conduct a process, for example.

Meanwhile, in the case of determining that operation is in progress in step S200, the brush apparatus 100 conducts a curvature information acquisition process that acquires curvature information (S202).

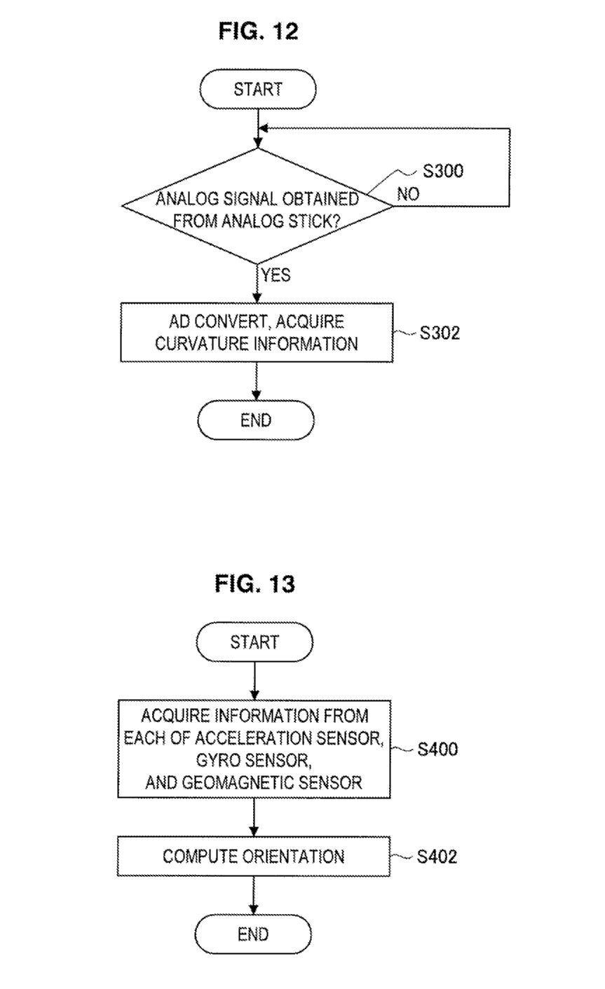

FIG. 12 is a flowchart for describing an example of a process by an information processing system 1000 according to the present embodiment, and illustrates an example of a curvature information acquisition process by the brush apparatus 100. Herein, FIG. 12 illustrates an example of a process for the case in which the curvature information acquisition unit of the brush apparatus 100 includes an analog stick, and acquires curvature information by a process according to the first example indicated in the above (i).

The brush apparatus 100 determines whether or not an analog signal has been obtained from the analog stick (S300). The brush apparatus 100 determines that an analog signal has been obtained from the analog stick in the case in which an analog signal is transmitted from the analog stick, for example.

In the case of not determining that an analog signal has been obtained in step S300, the brush apparatus 100 does not proceed with the process until determining that an analog signal has been obtained, for example.

In the case of determining that an analog signal has been obtained in step S300, the brush apparatus 100 AD-converts the analog signal obtained from the analog stick, and acquires data based on the analog signal as curvature information (S302).

By conducting the process illustrated in FIG. 12, for example, the brush apparatus 100 acquires curvature information. Note that, as discussed earlier, a process related to acquiring curvature information by a brush apparatus 100 according to the present embodiment is obviously not limited to a process according to the first example indicated in the above (i) as illustrated in FIG. 12.

Referring once again to FIG. 11, an example of a process by the brush apparatus 100 will be described. The brush apparatus 100 conducts an orientation information acquisition process that acquires brush apparatus orientation information indicating the orientation of the brush apparatus 100 (S204).

Note that although FIG. 11 illustrates an example of conducting the process in step S204 after conducting the process in step S202, it is also possible for the brush apparatus 100 to conduct the process in step S202 and the process in step S204 independently, for example. Consequently, the 100 may, for example, conduct the process in step S202 after the process in step S204, and may also conduct the process in step S202 and the process in step S204 synchronously or asynchronously.

FIG. 13 is a flowchart for describing an example of a process by an information processing system 1000 according to the present embodiment, and illustrates an example of an orientation information acquisition process by the brush apparatus 100.

The brush apparatus 100 acquires information (data indicating detection values) from the orientation sensor (S400). Herein, FIG. 13 illustrates an example in which the brush apparatus 100 acquires information from each of an acceleration sensor, a gyro sensor, and a geomagnetic sensor. Additionally, each of the acceleration sensor, gyro sensor, and geomagnetic sensor may be provided in the brush apparatus 100, or an external device to the brush apparatus 100, for example.

When information is acquired from the orientation sensor in step S400, the brush apparatus 100 performs computation according to an arbitrary method enabling the computation of a value related to orientation on the detection values indicated by the acquired information, and treats data expressing the computed value indicating an orientation as the brush apparatus orientation information (S402).

By conducting the process illustrated in FIG. 13, for example, the brush apparatus 100 acquires brush apparatus orientation information. A process related to acquiring brush apparatus orientation information by a brush apparatus 100 according to the present embodiment is not limited to the example illustrated in FIG. 13. For example, the brush apparatus 100 may also not conduct step S402 illustrated in FIG. 13 in the case of treating the information acquired from the orientation sensor in step S400 as the brush apparatus orientation information.

Referring once again to FIG. 11, an example of a process by the brush apparatus 100 will be described. The brush apparatus 100 transmits curvature information acquired by the process in step S202 and brush apparatus orientation information acquired by the process in step S204 to the information processing apparatus 200 (S206). Subsequently, the brush apparatus 100 repeats the process starting from step S200.

At this point, the brush apparatus 100 may transmit curvature information and brush apparatus orientation information individually or together, for example. The brush apparatus 100 transmits curvature information and brush apparatus orientation information via a communication unit (discussed later) or a connected external communication device, for example.

In the information processing system 1000, the brush apparatus 100 transmits information (data) according to operations on the operating surface to the information processing apparatus 200 by conducting the process illustrated in FIG. 11, for example. Obviously, however, a process of the brush apparatus 100 in the information processing system 1000 is not limited to the process illustrated in FIG. 11.

Referring once again to FIG. 10, an example of a process by an information processing system 1000 according to the present embodiment will be described. The information processing apparatus 200 conducts a drawing position acquisition process that acquires a position at which to draw (S104).

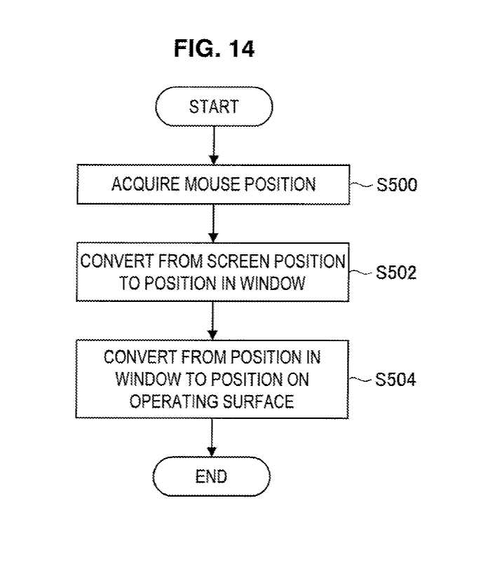

FIG. 14 is a flowchart for describing an example of a process by an information processing system 1000 according to the present embodiment, and illustrates an example of a drawing position acquisition process by the information processing apparatus 200. Herein, FIG. 14 illustrates an example of a drawing position acquisition process for the case in which an operating surface corresponds to a canvas, and the display screen on which the information processing apparatus 200 causes drawing is associated with the operating surface.

The information processing apparatus 200 acquires a mouse position specified by a mouse (one example of an operating device that is user-operable) (S500). When a mouse position is acquired, the information processing apparatus 200 converts the mouse position corresponding to a screen position to a position in a window (S502). Subsequently, the information processing apparatus 200 converts the position in a window that was converted in step S502 into a position on the operating surface (S504).

By conducting the process illustrated in FIG. 14, for example, the information processing apparatus 200 acquires a position at which to draw. Obviously, however, a drawing position acquisition process by the information processing apparatus 200 is not limited to the example illustrated in FIG. 14.

Referring once again to FIG. 10, an example of a process by an information processing system 1000 according to the present embodiment will be described. The information processing apparatus 200 conducts a tip contact region estimation process that estimates a contact region on the tip unit of the brush apparatus 100 (S106).

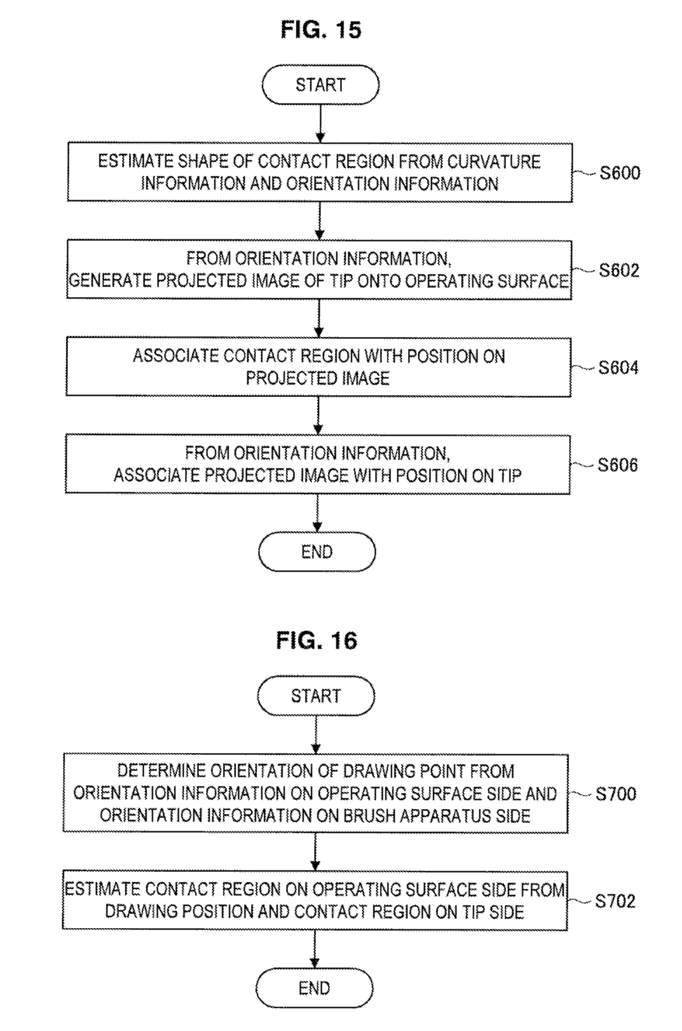

FIG. 15 is a flowchart for describing an example of a process by an information processing system 1000 according to the present embodiment, and illustrates an example of a tip contact region estimation process by the information processing apparatus 200. Herein, the process illustrated in FIG. 15 corresponds to another example of a process related to estimating a contact region on the tip unit of the brush apparatus 100 in the process in the above (1) (contact region estimation process) by the information processing apparatus 200.

The information processing apparatus 200 estimates the shape of a contact region from curvature information and orientation information transmitted from the brush apparatus 100 in the process in step S102 of FIG. 10 (S600).

From the orientation information, the information processing apparatus 200 generates a projected image of the tip (the tip unit of the brush apparatus 100) on the operating surface (S602). Subsequently, the information processing apparatus 200 associates the contact region with a position on the generated projected image (S604), and in addition, from the orientation information associates the projected image with a designated position on the tip (the tip unit of the brush apparatus 100 (S606).

By conducting the process illustrated in FIG. 15, for example, the information processing apparatus 200 estimates a contact region on the tip unit of the brush apparatus 100. Obviously, however, a tip contact region estimation process by the information processing apparatus 200 is not limited to the example illustrated in FIG. 15.

Referring once again to FIG. 10, an example of a process by an information processing system 1000 according to the present embodiment will be described. The information processing apparatus 200 conducts an operating surface contact region estimation process that estimates a contact region on the operating surface (S108).

FIG. 16 is a flowchart for describing an example of a process by an information processing system 1000 according to the present embodiment, and illustrates an example of an operating surface contact region estimation process by the information processing apparatus 200. Herein, the process illustrated in FIG. 16 corresponds to another example of a process related to estimating a contact region on the operating surface in the process in the above (1) (contact region estimation process) by the information processing apparatus 200.

The information processing apparatus 200 determines the orientation of a drawing point from orientation information related to the orientation on the side of the operating surface, and orientation information related to the orientation on the side of the brush apparatus 100 (S700). Herein, the orientation of a drawing point determined in step S700 may be, for example, the orientation of the tip on the tip unit of the brush apparatus 100 (corresponding to, for example, the orientation of the portion at the ends of the teardrop shapes illustrated in B1 to B3 of FIG. 3).

The information processing apparatus 200 estimates a contact region on the operating surface from a drawing position acquired in the process in step S104 of FIG. 10, and a contact region on the side of the tip (the side of the tip unit of the brush apparatus 100) estimated in the process in step S106 of FIG. 10 (S702).

By conducting the process illustrated in FIG. 16, for example, the information processing apparatus 200 estimates a contact region on the operating surface. Obviously, however, an operating surface contact region estimation process by the information processing apparatus 200 is not limited to the example illustrated in FIG. 16.

Referring once again to FIG. 10, an example of a process by an information processing system 1000 according to the present embodiment will be described. The information processing apparatus 200 conducts a paint transfer process that causes virtual paint to transfer (S110).

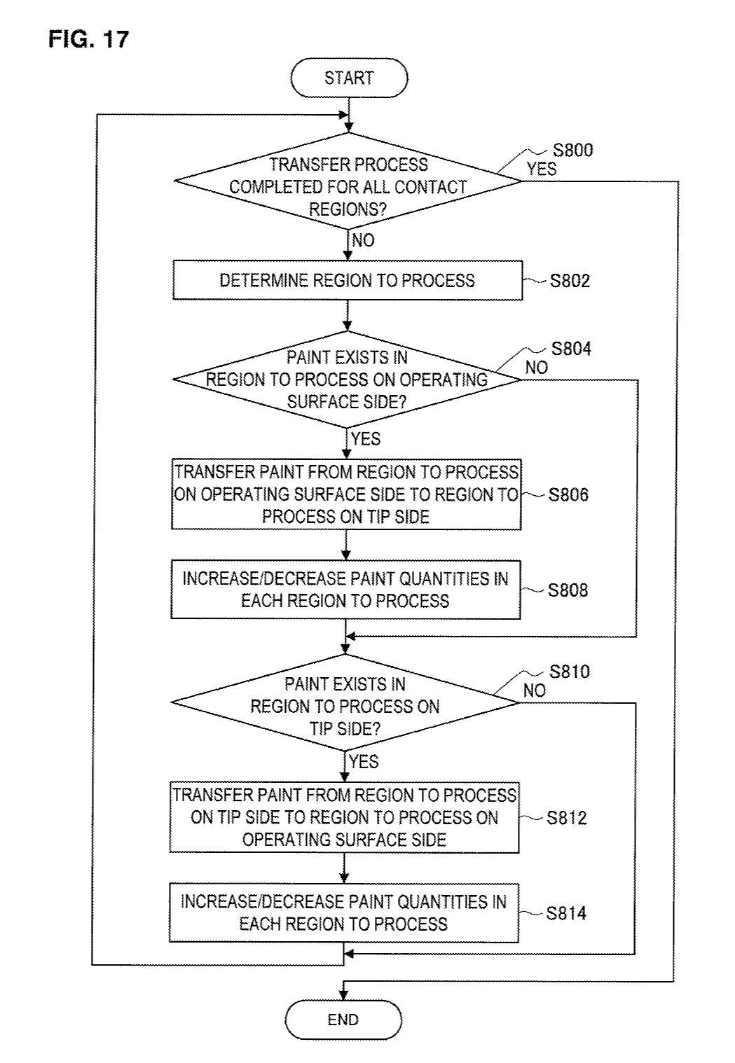

FIG. 17 is a flowchart for describing an example of a process by an information processing system 1000 according to the present embodiment, and illustrates an example of a paint transfer process by the information processing apparatus 200. Herein, the process illustrated in FIG. 17 illustrates an example of the process in the above (2) (drawing process) by the information processing apparatus 200, and illustrates an example of a process related to simulating the transfer of virtual paint. More specifically, the processing in steps S804 to S808 illustrated in FIG. 17 corresponds to an example of a process related to color mixing, while the processing in steps S810 to S814 corresponds to an example of a process related to drawing and kasure.

The information processing apparatus 200 determines whether or not the process related to the transfer of virtual paint has completed for all contact regions estimated in the processes in steps S106 and S108 of FIG. 10 (S800).

In the case of determining that the process related to the transfer of virtual paint has completed for all contact regions in step S800, the information processing apparatus 200 ends the paint transfer process.

Meanwhile, in the case of not determining that the process related to the transfer of virtual paint has completed for all contact regions in step S800, the information processing apparatus 200 determines a region to process (S802). At this point, the information processing apparatus 200 may treat an entire contact region as the region to process, or divide a contact region into multiple regions and treat a divided region as the region to process, for example.

The information processing apparatus 200 determines whether or not virtual paint exists in the region to process on the side of the operating surface (S804). The information processing apparatus 200 determines whether virtual paint exists in the region to process on the side of the operating surface by referencing a table or the like managed by the process in the above (3) (color management process), for example.

In the case of not determining that virtual paint exists in the region to process on the side of the operating surface in step S804, the information processing apparatus 200 conducts the process starting from step S810 discussed later.

Meanwhile, in the case of determining that virtual paint exists in the region to process on the side of the operating surface in step S804, the information processing apparatus 200 transfers virtual paint from the region to process on the side of the operating surface to the region to process on the side of the tip (the side of the tip unit of the brush apparatus 100) (S806).

When conducting the process in step S806, the information processing apparatus 200 increases or decreases the quantities of virtual paint respectively associated with the region to process on the side of the operating surface and the region to process on the side of the tip (the side of the tip unit of the brush apparatus 100), in accordance with the transfer (S808). Herein, the process in step S808 corresponds to the process in the above (3) (color management process).

In the case of not determining that virtual paint exists in the region to process on the side of the operating surface in step S804, or in the case of conducting the process in step S808, the information processing apparatus 200 determines whether or not virtual paint exists in the region to process on the side of the tip (the side of the tip unit of the brush apparatus 100) (S810). The information processing apparatus 200 determines whether virtual paint exists in the region to process on the side of the tip (the side of the tip unit of the brush apparatus 100) by referencing a table or the like managed by the process in the above (3) (color management process), for example.

In the case of not determining that virtual paint exists in the region to process on the side of the tip (the side of the tip unit of the brush apparatus 100) in step S810, the information processing apparatus 200 repeats the process starting from step S800.

Meanwhile, in the case of determining that virtual paint exists in the region to process on the side of the tip (the side of the tip unit of the brush apparatus 100) in step S810, the information processing apparatus 200 transfers virtual paint from the region to process on the side of the tip (the side of the tip unit of the brush apparatus 100) to the region to process on the side of the operating surface (S812).

When conducting the process in step S812, the information processing apparatus 200 increases or decreases the quantities of virtual paint respectively associated with the region to process on the side of the operating surface and the region to process on the side of the tip (the side of the tip unit of the brush apparatus 100), in accordance with the transfer (S814). Subsequently, the information processing apparatus 200 repeats the process starting from step S800. Herein, the process in step S814 corresponds to the process in the above (3) (color management process).

By conducting the process illustrated in FIG. 17, for example, the information processing apparatus 200 causes virtual paint to transfer. Obviously, however, a paint transfer process by the information processing apparatus 200 is not limited to the example illustrated in FIG. 17.

Referring once again to FIG. 10, an example of a process by an information processing system 1000 according to the present embodiment will be described. When the process in step S110 is conducted, the information processing apparatus 200 repeats the process starting from step S100.

In the information processing system 1000, the process illustrated in FIG. 10 is conducted, for example. Obviously, however, a process by the information processing system 1000 is not limited to the process illustrated in FIG. 10.

Exemplary configurations of brush apparatus and information processing apparatus constituting information processing system according to present embodiment

Next, respective exemplary configurations of the brush apparatus 100 and the information processing apparatus 200 capable of realizing a process by an information processing system according to the present embodiment discussed above will be described. The description hereinafter will take as an example the case in which the operating surface according to the present embodiment is the display screen of a display unit provided in the information processing device 200 (discussed later).

### [3-1] Brush Apparatus 100

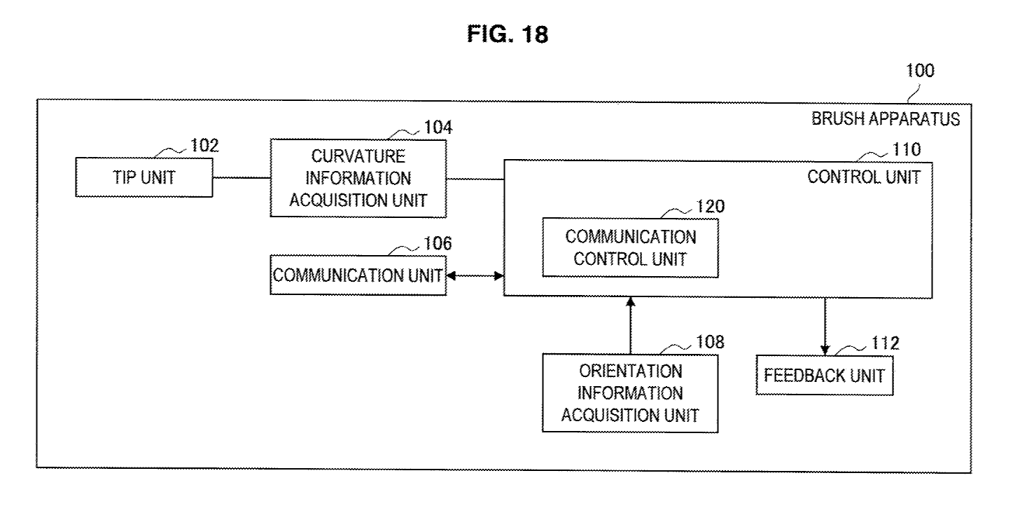

FIG. 18 is a block diagram illustrating an exemplary configuration of a brush apparatus 100 according to the present embodiment. The brush apparatus 100 is equipped with a tip unit 102, a curvature information acquisition unit 104, a communication unit 106, an orientation information acquisition unit 108, a control unit 110, and a feedback unit 112, for example.

The brush apparatus 100 may also be equipped with read-only memory (ROM; not illustrated) and random access memory (RAM; not illustrated), for example. Herein, the ROM (not illustrated) stores programs used by the control unit 110, control data such as computational parameters, and process data. The RAM (not illustrated) temporarily stores information such as programs executed by the control unit 110.

Furthermore, in the case in which the brush apparatus 100 is not configured to receive a supply of electric power from an external power supply such as an electric utility, for example, the brush apparatus 100 may be equipped with a power supply unit (not illustrated) that supplies power to each component. The power supply unit (not illustrated) may be, for example, a configuration that includes a power supply circuit and a battery, which may be a secondary battery such as a lithium-ion battery, or a primary battery such as an alkaline manganese battery.

The tip unit 102 fulfills the role of the tip of a brush. The tip unit 102 may be, for example, the tip of a real brush, or a conical cap resembling a brush tip (for example, a cap covering a device constituting a curvature information acquisition unit as illustrated in FIG. 6).

The curvature information acquisition unit 104 acquires curvature information. The curvature information acquisition unit 104 may be, for example, a configuration indicated in the above (i) to (iii).

The communication unit 106 is provided in the brush apparatus 100, and communicates with an external apparatus such as the information processing apparatus 200 in a wired or wireless manner via a network (or directly). In addition, communication in the communication unit 106 is controlled by, for example, the control unit 110 (more specifically, the communication control unit 120 discussed later, for example).

The communication unit 106 herein may be a communication antenna and radio frequency (RF) circuit (wireless communication), an IEEE 802.15.1 port and transceiver circuit (wireless communication), an IEEE 802.11b port and transceiver circuit (wireless communication), or a LAN port and transceiver circuit (wired communication), for example.

The orientation information acquisition unit 108 acquires brush apparatus orientation information (orientation information). The orientation information acquisition unit 108 is equipped with one or more orientation sensors that detect values usable for the detection of the orientation of the brush apparatus 100, such as an acceleration sensor, a gyro sensor, and a geomagnetic sensor, for example.

However, the configuration of the orientation information acquisition unit 108 is not limited to the above. For example, in the case in which the orientation sensor is an external device connected to the brush apparatus 100, the orientation information acquisition unit 108 may also be a hardware interface, connected to the above orientation sensor, that receives a signal indicating a detection value transmitted from the above orientation sensor.

The control unit 110 is made up of a micro-processing unit (MPU) or various processor circuits, for example, and fulfills the role of controlling the brush apparatus 100 overall. In addition, the control unit 110 is equipped with a communication control unit 120 that controls communication by the communication unit 106 or an external communication device, for example.

The communication control unit 120 causes curvature information acquired by the curvature information acquisition unit 104 and orientation information acquired by the orientation information acquisition unit 108 to be transmitted to the information processing apparatus 200. The communication control unit 120 causes the communication unit 106 or an external communication device to transmit curvature information and orientation information, for example.

Herein, the communication control unit 120 causes curvature information and orientation information to be transmitted to the information processing apparatus 200 by referencing data related to transmitting information being stored in ROM (not illustrated) or the like, for example. Data related to transmitting information according to the present embodiment may be, for example, address data of the information processing apparatus 200, a code for starting communication, or the like. Note that in the information processing system 1000, in the case of conducting one-to-one communication between the brush apparatus 100 and the information processing apparatus 200 (for example, in the case in which the brush apparatus 100 and the information processing apparatus 200 are connected by a dedicated connecting cable), the communication control unit 120 may also cause curvature information and orientation information to be transmitted without using data related to transmitting information as above, for example.

The control unit 110, by being equipped with the communication control unit 120, for example, causes curvature information and orientation information to be transmitted to the information processing apparatus 200.

The feedback unit 112 provides the user with tactile feedback with respect to an operation on the operating surface. Herein, a feedback unit provided in the brush apparatus 100 may be an actuator, for example.

Tactile feedback by the feedback unit 112 is controlled by the information processing apparatus 200, for example. Specifically, the feedback unit 112 conducts operations related to tactile feedback on the basis of a control signal received by the communication unit 106 (for example, a control signal causing the actuator to operate), for example.

According to the configuration illustrated in FIG. 18, for example, the brush apparatus 100 conducts a process in the information processing system 1000 according to the present embodiment discussed above, and transmits acquired curvature information and orientation information to the information processing apparatus 200.

However, the configuration of the brush apparatus 100 according to the present embodiment is not limited to the example illustrated in FIG. 18.

For example, the brush apparatus 100 may also not be equipped with the communication unit 106 in the case in which the brush apparatus 100 is configured to transmit various information such as curvature information and orientation information via an external communication device.

As another example, the brush apparatus 100 may also not be equipped with the feedback unit 112 in the case in which the brush apparatus 100 is configured to not provide the user with tactile feedback.

### [3-2] Information Processing Apparatus

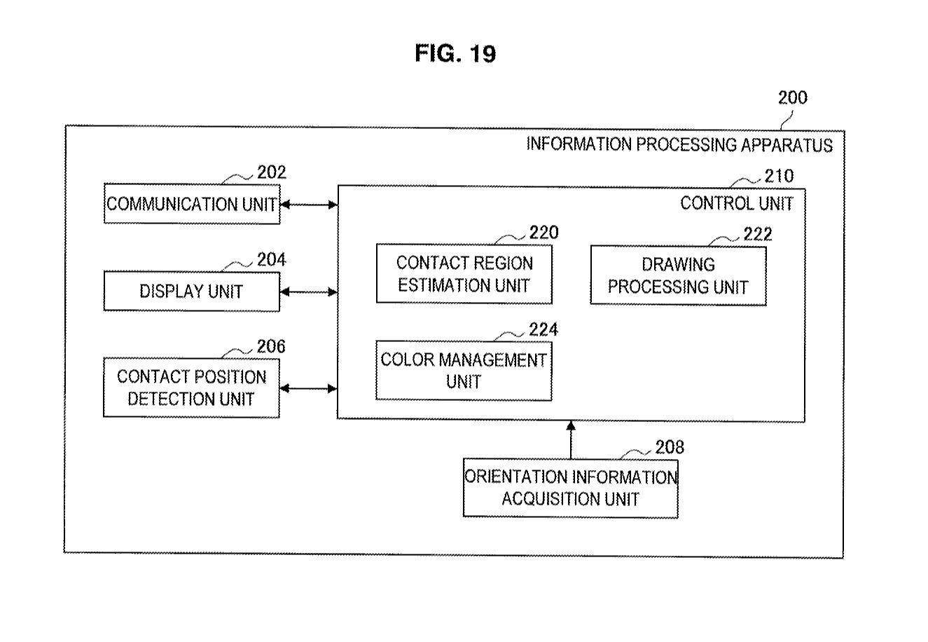

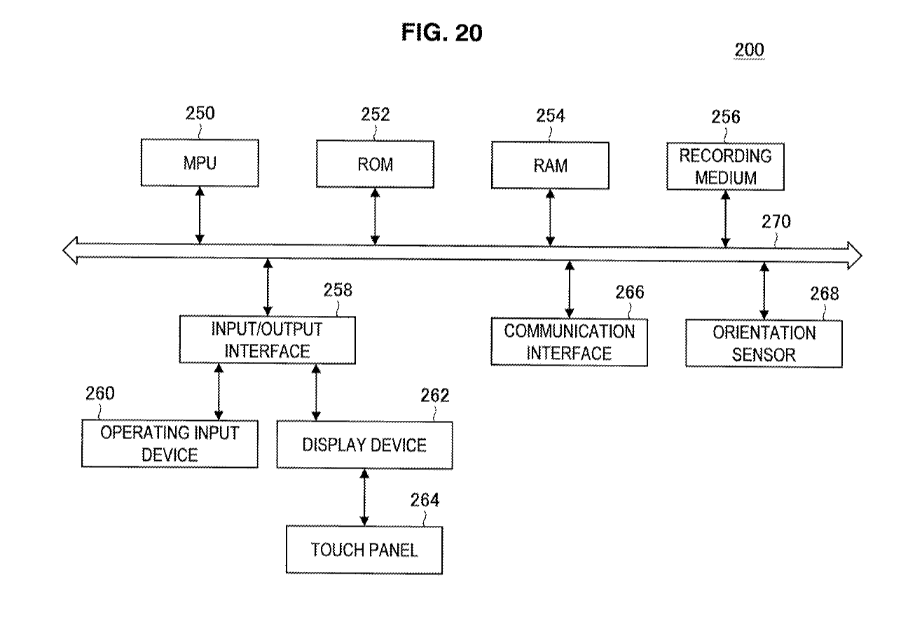

FIG. 19 is a block diagram illustrating an exemplary configuration of an information processing apparatus 200 according to the present embodiment. The information processing apparatus 200 is equipped with a communication unit 202, a display unit 204, a contact position detection unit 206, an orientation information acquisition unit 208, and a control unit 210, for example.

The information processing apparatus 200 may also be equipped with ROM (not illustrated), RAM (not illustrated), a storage unit (not illustrated), and an operating unit (not illustrated) that is operable by the user, for example. The above respective structural elements in the information processing apparatus 200 are connected to each other via a bus that acts as a data transmission line, for example.

Herein, the ROM (not illustrated) stores programs and control data such as computational parameters used by the control unit 210. The RAM (not illustrated) temporarily stores information such as programs executed by the control unit 210. Also, the storage unit (not illustrated) may be a recording medium discussed later, and the operating unit (not illustrated) may be an operating input device discussed later.

### [Exemplary Hardware Configuration of Information Processing Apparatus 200]

FIG. 20 is an explanatory diagram illustrating an example of a hardware configuration of an information processing apparatus 200 according to the present embodiment. The information processing apparatus 200 is equipped with an MPU 250, ROM 252, RAM 254, a recording medium 256, an input/output interface 258, an operating input device 260, a display device 262, a touch panel 264, a communication interface 266, and an orientation sensor 268, for example. Also, the respective structural elements in the information processing apparatus 200 are connected to each other via a bus 270 that acts as a data transmission line, for example.

The MPU 250 is made up of an MPU or various processor circuits, for example, and functions as the control unit 210 that controls the information processing apparatus 200 overall. In addition, in the information processing apparatus 200, the MPU 250 fulfills the roles of a contact region estimation unit 220, a drawing processing unit 222, and a color management unit 224 discussed later, for example.

The ROM 252 stores programs and control data such as computational parameters used by the MPU 250. The RAM 254 temporarily stores information such as programs executed by the MPU 250, for example.

The recording medium 256 functions as a storage unit (not illustrate), and stores various data such as a table or other data related to a color management process, and applications, for example. Herein, the recording medium 256 may be, for example, a magnetic recording medium such as a hard disk, or non-volatile memory such as flash memory. Additionally, the recording medium 256 may also be removable from the information processing apparatus 200.

The input/output interface 258 connects to the operating input device 260 and the display device 262, for example. The operating input device 260 functions as an operating unit (not illustrated), while the display device 262 functions as the display unit 204. Herein, the input/output interface 258 may be, for example, a Universal Serial Bus (USB) port, a Digital Visual Interface (DVI) port, a High-Definition Multimedia Interface (HDMI) port, various processor circuits, and the like, for example. Additionally, the operating input device 260 is provided on the information processing apparatus 200 and internally connected to the input/output interface 258 inside the information processing apparatus 200, for example. The operating input device 260 may be, for example, buttons, directional keys, a jog dial or other rotary selector, or some combination thereof. Additionally, the display device 262 is provided on the information processing apparatus 200 and internally connected to the input/output interface 258 inside the information processing apparatus 200, for example. The display device 262 may be, for example, a liquid crystal display (LCD) or an organic electroluminescent display (also called an organic light-emitting diode (OLED) display).

Note that obviously the input/output interface 258 may also be connected to an external device, such as an operating input device (such as a keyboard or mouse, for example) or a display device that is an external apparatus to the information processing apparatus 200.

The touch panel 264 fulfills the role of the contact position detection unit 206, and detects a contact position of the tip unit 102 of the brush apparatus 100 with respect to the display screen of the display device 262, for example. Herein, the touch panel 264 may be a touch panel of any of various methods, such as an optical touch panel, a capacitive touch panel, or an inductive touch panel, for example.

The communication interface 266 is provided in the information processing apparatus 200, and functions as the communication unit 202 for communicating with an external apparatus such as the brush apparatus 100 in a wired or wireless manner via a network (or directly). The communication interface 266 herein may be a communication antenna and RF circuit (wireless communication), an IEEE 802.15.1 port and transceiver circuit (wireless communication), an IEEE 802.11b port and transceiver circuit (wireless communication), or a LAN port and transceiver circuit (wired communication), for example.

The orientation sensor 268 detects values that is usable for the detection of the orientation of the display screen of the display device 262 (one example of an operating surface), for example. In the information processing apparatus 200, the orientation sensor 268 fulfills the role of the orientation information acquisition unit 208, for example. Herein, the orientation sensor 268 may be one or more sensor devices that are usable for the detection of orientation, such as an acceleration sensor, a gyro sensor, or a geomagnetic sensor, for example.

According to the configuration illustrated in FIG. 20, for example, the information processing apparatus 200 conducts a process of an information processing apparatus in an information processing system according to the present embodiment discussed above. However, the hardware configuration of an information processing apparatus 200 according to the present embodiment is not limited to the configuration illustrated in FIG. 20.

For example, the information processing apparatus 200 may also be equipped with multiple communication interfaces having the same communication scheme, or different communication schemes.

As another example, the information processing apparatus 200 may also not be equipped with the communication interface 266 in the case of communicating with an external apparatus such as the brush apparatus 100 via an external communication device connected via the input/output interface 258 or the like.

As another example, the information processing apparatus 200 may also not be equipped with the touch panel 264 in the case in which the operating surface according to the present embodiment is not the display screen of the display device 262.

Additionally, in the case in which the operating surface according to the present embodiment is not the display screen of the display device 262, the information processing apparatus 200 may also be equipped with a pointing device capable of detecting a contact position by various methods, such as optical capacitive, or inductive methods, for example. In the case of equipping the above pointing device, the detecting face of the pointing device fulfills the role of an operating surface according to the present embodiment, for example.

As another example, the information processing apparatus 200 may also not be equipped with the orientation sensor 268 in the case of a configuration that acquires operating surface orientation information from an external orientation device via the input/output interface 258 and communication interface 266 or the like, or in the case of conducting the process in the above (1) (contact region estimation process) without using operating surface orientation information.

In addition, it is also possible for the information processing apparatus 200 to take a configuration that is not equipped with the operating input device 260 or the display device 262, for example.

Referring again to FIG. 19, an example of a configuration of the information processing apparatus 200 will be described. The communication unit 202 is provided in the information processing apparatus 200, and communicates with an external device such as the brush apparatus 100 in a wired or wireless manner via a network (or directly). In addition, communication in the communication unit 202 is controlled by the control unit 210, for example.

The communication unit 202 herein may be a communication antenna and RF circuit (wireless communication), an IEEE 802.15.1 port and transceiver circuit (wireless communication), an IEEE 802.11b port and transceiver circuit (wireless communication), or a LAN port and transceiver circuit (wired communication), for example.

The display unit 204 displays various screens on a display screen. The display unit 204 may be, for example, a liquid crystal display or an organic EL display.

The contact position detection unit 206 detects a contact position of the tip unit 102 of the brush apparatus 100 with respect to the operating surface, for example. Subsequently, the contact position detection unit 206 transmits position information indicating a detected position to the control unit 210.

Herein, the contact position detection unit 206 may be, for example, a touch panel capable of detecting a contact position by various methods such as optical, capacitive, or inductive methods (in the case in which the operating surface corresponds to the display screen of the display unit 204, for example). Also, the contact position detection unit 206 may be, for example, a pointing device capable of detecting a contact position by various methods as above (in the case in which the operating surface is a detection surface of the contact position detection unit 206 that does not correspond to the display screen of the display unit 204, for example).

The orientation information acquisition unit 208 fulfills the role of acquiring operating surface orientation information (orientation information). The orientation information acquisition unit 208 is equipped with one or more orientation sensors that detect values usable for the detection of the orientation of the brush apparatus 100, such as an acceleration sensor, a gyro sensor, and a geomagnetic sensor, for example.

However, the configuration of the orientation information acquisition unit 208 is not limited to the above. For example, in the case in which the orientation sensor is an external device to the information processing apparatus 200, the orientation information acquisition unit 208 may also be a hardware interface, connected to the above orientation sensor, that receives a signal indicating a detection value transmitted from the above orientation sensor. Also, in the case in which the orientation sensor is an external device to the information processing apparatus 200, the communication unit 202 may also fulfill the role of the orientation information acquisition unit 208.

The control unit 210 is made up of an MPU or various processor circuits, for example, and fulfills the role of controlling the information processing apparatus 200 overall. Additionally, the control unit 210 is equipped with a contact region estimation unit 220, a drawing processing unit 222, and a color management unit 224, for example, and fulfills the leading role of conducting processes of an information processing apparatus in an information processing system according to the present embodiment discussed above.

The contact region estimation unit 220 fulfills the leading role of conducting the process in the above (1) (contact region estimation process).

The contact region estimation unit 220 estimates contact regions of the tip unit of the brush apparatus 100 and the operating surface on the basis of information corresponding to operations on the operating surface transmitted from the brush apparatus 100 (curvature information and brush apparatus orientation information), and position information, for example. In addition, it is also possible for the contact region estimation unit 220 to estimate contact regions on the tip unit of the brush apparatus 100 and the operating surface on the additional basis of operating surface orientation information (orientation information), for example. Herein, the contact region estimation unit 220 uses information corresponding to operations on the operating surface transmitted from the communication unit 202 for processing, for example. In addition, the contact region estimation unit 220 may also use position information transmitted from the contact position detection unit 206, for example. Also, in the case of conducting the process in the above (1) (contact region estimation process) using operating surface orientation information, the contact region estimation unit 220 uses operating surface orientation information transmitted from the orientation information acquisition unit 208 for processing, for example.

More specifically, the contact region estimation unit 220 estimates a contact region on the operating surface on the basis of a “curvature magnitude of the tip unit of the brush apparatus 100” computed on the basis of curvature information, and an “angle of the tip unit of the brush apparatus 100 with respect to the operating surface” computed on the basis of the curvature magnitude and brush apparatus orientation information, for example. Also, in the case of conducting the process in the above (1) (contact region estimation process) using operating surface orientation information, the contact region estimation unit 220 computes the “angle of the tip unit of the brush apparatus 100 with respect to the operating surface” on the additional basis of operating surface orientation information, for example. Additionally, the contact region estimation unit 220 estimates a contact region on the tip unit of the brush apparatus 100 on the basis of a “contactable region”, which is the largest region on the operating surface from among regions that the tip unit of the brush apparatus 100 is capable of contacting, and an “estimated contact region on the operating surface”, for example. However, a process by the contact region estimation unit 220 is not limited to the above, as illustrated by taking steps S106 and S108 of FIG. 10 as examples.

The drawing processing unit 222 fulfills the leading role of conducting the process in the above (2) (drawing process), and causes drawing according to operations on the operating surface by the brush apparatus 100 to be conducted on a display screen on the basis of the estimation results for contact regions estimated by the contact region estimation unit 220, for example.

Herein, in the case of causing drawing to be conducted on the display screen of the display unit 204, the drawing processing unit 222 causes drawing according to operations on the operating surface by the brush apparatus 100 to be conducted on the display screen of the display unit 204 by transmitting an image signal corresponding to the drawing content to the display unit 204, for example. Note that the display screen on which the drawing processing unit 222 causes drawing is not limited to the display screen of the display unit 204. For example, the drawing processing unit 222 may also cause drawing according to operations on the operating surface by the brush apparatus 100 to be conducted on the display screen of an external display device by causing the communication unit 202 to transmit an image signal corresponding to the drawing content to that external display device.

In addition, the drawing processing unit 222 may also conduct processes according to the first through fifth examples illustrated in the above (a) to (e), for example.

The color management unit 224 fulfills the leading role of conducting the process in the above (3) (color management process), and manages virtual paint associated with the tip unit of the brush apparatus 100, and virtual paint associated with a corresponding region on a display screen.

By being equipped with the contact region estimation unit 220, the drawing processing unit 222, and the color management unit 224, for example, the control unit 210 leads processes of an information processing apparatus in an information processing system according to the present embodiment discussed above.

With the configuration illustrated in FIG. 19, for example, the information processing apparatus 200 conducts processes in an information processing system 1000 according to the present embodiment discussed above, and causes drawing according to operations on an operating surface by the brush apparatus 100 to be conducted on a display screen.

Herein, by conducting the process in the above (1) (contact region estimation process) with the contact region estimation unit 220, the information processing apparatus 200 estimates a curvature magnitude and a tilt magnitude of the tip unit of the brush apparatus 100 with respect to the operating surface, and estimates contact regions on the tip unit of the brush apparatus 100 and the operating surface. Thus, even if the orientation of the brush apparatus 100 successively varies due to user operations, for example, the information processing apparatus 200 is able to more accurately estimate contact regions on the tip unit of the brush apparatus 100 and the operating surface.

Additionally, by conducting the process in the above (2) (drawing process) with the drawing processing unit 222, the information processing apparatus 200 causes drawing according to operations on an operating surface by the brush apparatus 100 to be conducted on a display screen on the basis of contact region estimation results.

Consequently, with the configuration illustrated in FIG. 19, for example, the information processing apparatus 200 is able to realize drawing as though actually drawn with a brush.

Also, the process in the above (1) (contact region estimation process) and the process in the above (2) (drawing process) by the information processing apparatus 200 do not require extremely compute-intensive processing such as a 3D profile simulation of the tip, for example. Accordingly, the information processing apparatus 200 is able to realize drawing as though actually drawn with a brush, with a smaller computational load.

Additionally, by conducting the process in the above (3) (color management process) with the color management unit 224, the information processing apparatus 200 is able to more closely simulate “the transfer of virtual paint from a contact region on the tip unit of the brush apparatus 100 to a corresponding region on a display screen that corresponds to a contact region on the operating surface” and “the transfer of virtual paint from a contact region on the operating surface that corresponds to that corresponding region to a contact region on the tip unit of the brush apparatus 100”, for example.

However, the configuration of the information processing apparatus 200 according to the present embodiment is not limited to the example illustrated in FIG. 19.

For example, it is also possible for an information processing apparatus 200 according to the present embodiment to take a configuration that is not equipped with the color management unit 224. Even with a configuration that is not equipped with the color management unit 224, an information processing apparatus 200 according to the present embodiment is still able to conduct the process in the above (1) (contact region estimation process) and the process in the above (2) (drawing process), and thus the information processing apparatus 200 is able to realize drawing as though actually drawn with a brush.

As another example, an information processing apparatus 200 according to the present embodiment may be equipped with one or more from among the contact region estimation unit 220, the drawing processing unit 222, and the color management unit 224, separately from the control unit 210 (realized with separate process circuits, for example).

As another example, an information processing apparatus 200 according to the present embodiment may also not be equipped with the communication unit 202 in the case in which the information processing apparatus 200 communicates with an external apparatus such as the brush apparatus 100 via an external communication device.

Additionally, an information processing apparatus 200 according to the present embodiment may also not be equipped with the display unit 204 in the case in which the information processing apparatus 200 causes drawing according to operations on the operating surface by the brush apparatus 100 to be conducted on the display screen of a display device external thereto.

As another example, an information processing apparatus 200 according to the present embodiment may also not be equipped with the contact position detection unit 206 in the case in which an operating surface according to the present embodiment is the detection surface of a display screen on a display device or a pointing device in an external device to the information processing apparatus 200.

As another example, an information processing apparatus 200 according to the present embodiment may also not be equipped with the orientation information acquisition unit 208 in the case in which an operating surface according to the present embodiment is the detection surface of a display screen on a display device or a pointing device in an external device to the information processing apparatus 200, and operating surface orientation information is acquirable via the communication unit 202 or an external communication device, or in the case of conducting the process in the above (1) (contact region estimation process) without using operating surface orientation information.

An information processing system 1000 includes a brush apparatus 100 with a configuration as illustrated in FIG. 18, and an information processing apparatus 200 with a configuration as illustrated in FIG. 19, for example.

In the information processing system 1000, the brush apparatus 100, by conducting the process indicated in the above section [1-1], for example, transmits information corresponding to user operations on the operating surface (for example, curvature information and brush apparatus orientation information) to the information processing apparatus 200 via the communication unit 106 or an external communication device. Also, in the information processing system 1000, the information processing apparatus 200, by conducting the process indicated in the above section [1-2], for example, causes drawing according to operations performed on the operating surface by the brush apparatus 100 to be conducted on a display screen.

Herein, in the process in the above (1) (contact region estimation process), the information processing apparatus 200 estimates contact regions on the tip unit of the brush apparatus 100 and the operating surface, on the basis of curvature information and brush apparatus orientation information transmitted from the brush apparatus 100, and position information, for example. In addition, in the process in the above (1) (contact region estimation process), it is also possible for the information processing device 200 to estimate contact regions on the tip unit of the brush apparatus 100 and the operating surface on the additional basis of operating surface orientation information, for example. Thus, even if the orientation of the brush apparatus 100 successively varies due to user operations, for example, the information processing apparatus 200 is able to more accurately estimate contact regions on the tip unit of the brush apparatus 100 and the operating surface. Additionally, in the process in the above (2) (drawing process), the information processing apparatus 200 causes drawing according to operations on an operating surface by the brush apparatus 100 to be conducted on a display screen on the basis of contact region estimation results.

Consequently, by including the brush apparatus 100 and the information processing apparatus 200, for example, there is realized an information processing system capable of realizing drawing as though actually drawn with a brush.

As another example, in the case in which the information processing apparatus 200 conducts a process related to the transfer of virtual paint, the expression of uneven color when virtual paints mix, more accurate expression of the flow of virtual paint, and the expression of kasure may be realized more precisely in the information processing system 1000.

As another example, by including the brush apparatus 100 and the information processing apparatus 200, there is realized an information processing system that satisfies the three conditions of expressing drawing by direct operations by the user, expressing the tactile sensation of a brush, and expressing the (unidirectional, or alternatively, bidirectional) transfer of virtual paint.

Also, in the information processing system 1000, since the information processing apparatus 200 is able to estimate a contact region on the tip unit of the brush apparatus 100, it is also possible to add the new information (data) of a contact region on the tip unit of the brush apparatus 100 to various existing drawing simulations. Accordingly, by using the information processing system 1000, a drawing simulation which is applied to an existing drawing simulation and which enhances the existing drawing simulation may also be realized, for example.

Although the foregoing describes a brush apparatus as an example of a structural element of an information processing system according to the present embodiment, the present embodiment is not limited to such a configuration. The present embodiment may also be, for example, a stylus-shaped apparatus, or an attachment-shaped apparatus that attaches to an existing stylus and is used together with the existing stylus.

Additionally, although the foregoing describes an information processing apparatus as an example of a structural element of an information processing system according to the present embodiment, the present embodiment is not limited to such a configuration. The present embodiment may be applied to various equipment, such as a tablet apparatus, a communication apparatus such as a mobile phone or smartphone, a video/music player apparatus (or a video/music recording and playback apparatus), a game console, a computer such as a server or personal computer (PC), or the like, for example. Additionally, the present embodiment may also be applied to a processing integrated circuit (IC) embeddable in equipment like the above, for example.

### (Program According to Present Embodiment)

It is possible to realize drawing as though actually drawn with a brush by executing, on a computer, a program for causing the computer to function as an information processing apparatus according to the present embodiment (for example, a program capable of executing processes of an information processing apparatus in an information processing system according to the present embodiment, such as “the process in the above (1) (contact region estimation process) as well as the process in the above (2) (drawing process)”, or “the process in above (1) (contact region estimation process), the process in the above (2) (drawing process), and the process in the above (3) (color management process)”).

The foregoing thus describes a preferred embodiment of the present disclosure in detail and with reference to the attached drawings. However, the technical scope of the present disclosure is not limited to such an example. It is clear to persons ordinarily skilled in the technical field of the present disclosure that various modifications or alterations may occur insofar as they are within the scope of the technical ideas stated in the claims, and it is to be understood that such modifications or alterations obviously belong to the technical scope of the present disclosure.

For example, although the above indicates that a program for causing a computer to function as an information processing apparatus according to the present embodiment (a computer program) is provided, in the present embodiment, the above program may also be provided in conjunction with a recording medium having the program recorded thereon.

The foregoing configuration illustrates one example of the present embodiment, and obviously belongs to the technical scope of the present disclosure.

Additionally, the present technology may also be configured as below.

(1) An information processing system including:

a brush apparatus that fulfills a role of a brush; and

an information processing apparatus that causes drawing according to an operation on an operating surface by the brush apparatus to be conducted on a display screen,

wherein the brush apparatus includes
a tip unit that fulfills a role of a tip on the brush,
a curvature information acquisition unit that acquires curvature information indicating a curvature state of the tip unit due to an operation on the operating surface,
an orientation information acquisition unit that acquires brush apparatus orientation information indicating an orientation of the brush apparatus, and
a communication control unit that causes the curvature information and the brush apparatus orientation information to be transmitted to the information processing apparatus, and

wherein the information processing apparatus includes
a contact region estimation unit that estimates a contact region on the tip unit of the brush apparatus and the operating surface, on a basis of the curvature information and the brush apparatus orientation information transmitted from the brush apparatus, and position information indicating a contact position of the tip unit of the brush apparatus on the operating surface, and
a drawing processing unit that causes drawing according to an operation on the operating surface by the brush apparatus to be conducted on the display screen, on a basis of estimation results for the contact region.

(2) The information processing system according to (1), wherein the drawing processing unit

simulates transfer of virtual paint between the tip unit of the brush apparatus and a corresponding region of the display screen that corresponds to the contact region on the operating surface, and

causes drawing based on simulation results to be conducted on the display screen.

(3) The information processing system according to (2), further including:

a color management unit that manages virtual paint associated with the tip unit of the brush apparatus, and virtual paint associated with the corresponding region,

wherein the drawing processing unit simulates transfer of virtual paint on a basis of virtual paint associated with the tip unit of the brush apparatus and virtual paint associated with the corresponding region that are managed by the color management unit.

(4) The information processing system according to (3), wherein, in a case of simulating transfer of virtual paint, the color management unit conducts color mixing between virtual paint associated with the tip unit of the brush apparatus and virtual paint transferred from the corresponding region, and/or color mixing between virtual paint associated with the corresponding region and virtual paint transferred from the tip unit of the brush apparatus.

(5) The information processing system according to any one of (2) to (4), wherein the drawing processing unit simulates both transfer of virtual paint from the tip unit of the brush apparatus to the corresponding region, and transfer of virtual paint from the corresponding region to the tip unit of the brush apparatus.

(6) The information processing system according to any one of (3) to (5), wherein the color management unit manages the virtual paint associated with the tip unit of the brush apparatus at respective coordinates for each position in a contactable region, the contactable region being the largest region on the operating surface from among regions that the tip unit of the brush apparatus is capable of contacting.

(7) The information processing system according to any one of (3) to (5), wherein the color management unit manages virtual paint associated with the tip unit of the brush apparatus at respective coordinates for each position in a fan-shaped region that corresponds to change in a contactable region due to rotation of the brush apparatus on the tip unit of the brush apparatus, the contactable region being a largest region on the operating surface from among regions that the tip unit of the brush apparatus is capable of contacting.

(8) The information processing system according to any one of (4) to (7),

wherein the tip unit of the brush apparatus includes a color change mechanism enabling a color to be changed, and

wherein the drawing processing unit controls changes of color on the tip unit of the brush apparatus, on a basis of simulation results for transfer of virtual paint from the corresponding region to the tip unit of the brush apparatus.

(9) The information processing system according to (8), wherein the color change mechanism included in the tip unit of the brush apparatus includes a light-emitting element.

(10) The information processing system according to (8), wherein the color change mechanism included in the tip unit of the brush apparatus includes a material whose color changes according to an applied voltage.

(11) The information processing system according to any one of (1) to (10), wherein the drawing processing unit

detects an upward flick of the tip unit of the brush apparatus on a basis of the curvature information, and

causes drawing of an upward flick to be conducted on the display screen in a case in which the upward flick is detected.

(12) The information processing system according to any one of (1) to (11),

wherein the brush apparatus further includes a feedback unit that provides a user with tactile feedback with respect to an operation on the operating surface, and

wherein the drawing processing unit controls the tactile feedback by the feedback unit of the brush apparatus, on a basis of estimation results for the contact region.

(13) The information processing system according to (12), wherein the drawing processing unit controls the tactile feedback by the feedback unit of the brush apparatus, on an additional basis of a set drawing mode.

(14) The information processing system according to any one of (1) to (13), wherein the contact region estimation unit

estimates a shape of a contact region on the tip unit of the brush apparatus, on a basis of a curvature magnitude of the tip unit of the brush apparatus that is computed on a basis of the curvature information, and an angle of the tip unit of the brush apparatus with respect to the operating surface that is computed on a basis of the curvature magnitude and the brush apparatus orientation information, and

estimates a contact region on the tip unit of the brush apparatus, on a basis of a contactable region, the contactable region being a largest region on the operating surface from among regions that the tip unit of the brush apparatus is capable of contacting, and the estimated shape of the contact region on the tip unit of the brush apparatus.

(15) The information processing system according to (14), wherein the contact region estimation unit computes an angle of the tip unit of the brush apparatus with respect to the operating surface, on an additional basis of operating surface orientation information indicating an orientation of the operating surface.

(16) An information processing device including:

a contact region estimation unit that estimates a contact region on a tip unit, which fulfills a role of a tip on a brush of a brush apparatus that fulfills a role of a brush, and an operating surface, on a basis of curvature information indicating a curvature state of the tip unit of the brush apparatus with respect to the operating surface and brush apparatus orientation information indicating an orientation of the brush apparatus, which are transmitted from the brush apparatus, and position information indicating a contact position of the tip unit of the brush apparatus on the operating surface; and a drawing processing unit that causes drawing according to an operation on the operating surface by the brush apparatus to be conducted on a display screen, on a basis of estimation results for the contact region.

(17) A brush apparatus including:

a tip unit that fulfills a role of a tip on a brush;

a curvature information acquisition unit that acquires curvature information indicating a curvature state of the tip unit with respect to an operating surface;

an orientation information acquisition unit that acquires orientation information indicating an orientation of the brush apparatus; and

a communication control unit that causes the curvature information and the orientation information to be transmitted to an information processing apparatus that causes drawing according to an operation on the operating surface by the brush apparatus to be conducted on a display screen.

(18) The brush apparatus according to (17), wherein the curvature information acquisition unit

includes an analog stick, and

takes the curvature information to be information based on an analog magnitude that corresponds to a degree of tilt of the analog stick.

(19) The brush apparatus according to (17),

wherein the tip unit includes a conductive material whose resistance value changes depending on a curvature position, and

wherein the curvature information acquisition unit acquires the curvature information by estimating a curvature state of the tip unit from a distribution of resistance values on the tip unit.

(20) The brush apparatus according to (17), wherein the curvature information acquisition unit acquires the curvature information by estimating a curvature state of the tip unit on a basis of relative positions of a first detection point and a second detection point on the tip unit.

(21) The brush apparatus according to any one of (17) to (20), further including:

a communication unit capable of communicating with the information processing apparatus.

What is claimed is:

1. An information processing system comprising:
a brush apparatus that fulfills a role of a brush; and
an information processing apparatus that causes drawing according to an operation on an operating surface by the brush apparatus to be conducted on a display screen,
wherein the brush apparatus includes
a tip unit that fulfills a role of a tip on the brush,
a curvature information acquisition unit that acquires curvature information indicating a curvature state of the tip unit due to an operation on the operating surface,
an orientation information acquisition unit that acquires brush apparatus orientation information indicating an orientation of the brush apparatus, and
a communication control unit that causes the curvature information and the brush apparatus orientation information to be transmitted to the information processing apparatus, and
wherein the information processing apparatus includes
a contact region estimation unit that estimates a contact region on the tip unit of the brush apparatus and the operating surface, on a basis of the curvature information and the brush apparatus orientation information transmitted from the brush apparatus, and position information indicating a contact position of the tip unit of the brush apparatus on the operating surface, and
a drawing processing unit that causes drawing according to an operation on the operating surface by the brush apparatus to be conducted on the display screen, on a basis of estimation results for the contact region.

2. The information processing system according to claim 1, wherein the drawing processing unit
simulates transfer of virtual paint between the tip unit of the brush apparatus and a corresponding region of the display screen that corresponds to the contact region on the operating surface, and
causes drawing based on simulation results to be conducted on the display screen.

3. The information processing system according to claim 2, further comprising:
a color management unit that manages virtual paint associated with the tip unit of the brush apparatus, and virtual paint associated with the corresponding region,
wherein the drawing processing unit simulates transfer of virtual paint on a basis of virtual paint associated with the tip unit of the brush apparatus and virtual paint associated with the corresponding region that are managed by the color management unit.

4. The information processing system according to claim 3, wherein, in a case of simulating transfer of virtual paint, the color management unit conducts color mixing between virtual paint associated with the tip unit of the brush apparatus and virtual paint transferred from the corresponding region, and/or color mixing between virtual paint associated with the corresponding region and virtual paint transferred from the tip unit of the brush apparatus.

5. The information processing system according to claim 2, wherein the drawing processing unit simulates both transfer of virtual paint from the tip unit of the brush apparatus to the corresponding region, and transfer of virtual paint from the corresponding region to the tip unit of the brush apparatus.

6. The information processing system according to claim 3, wherein the color management unit manages the virtual paint associated with the tip unit of the brush apparatus at respective coordinates for each position in a contactable region, the contactable region being the largest region on the operating surface from among regions that the tip unit of the brush apparatus is capable of contacting.

7. The information processing system according to claim 3, wherein the color management unit manages virtual paint associated with the tip unit of the brush apparatus at respective coordinates for each position in a fan-shaped region that corresponds to change in a contactable region due to rotation of the brush apparatus on the tip unit of the brush apparatus, the contactable region being a largest region on the operating surface from among regions that the tip unit of the brush apparatus is capable of contacting.

8. The information processing system according to claim 4,
wherein the tip unit of the brush apparatus includes a color change mechanism enabling a color to be changed, and
wherein the drawing processing unit controls changes of color on the tip unit of the brush apparatus, on a basis of simulation results for transfer of virtual paint from the corresponding region to the tip unit of the brush apparatus.

9. The information processing system according to claim 8, wherein the color change mechanism included in the tip unit of the brush apparatus includes a light-emitting element.

10. The information processing system according to claim 8, wherein the color change mechanism included in the tip unit of the brush apparatus includes a material whose color changes according to an applied voltage.

11. The information processing system according to claim 1, wherein the drawing processing unit
detects an upward flick of the tip unit of the brush apparatus on a basis of the curvature information, and
causes drawing of an upward flick to be conducted on the display screen in a case in which the upward flick is detected.

12. The information processing system according to claim 1,
wherein the brush apparatus further includes a feedback unit that provides a user with tactile feedback with respect to an operation on the operating surface, and
wherein the drawing processing unit controls the tactile feedback by the feedback unit of the brush apparatus, on a basis of estimation results for the contact region.

13. The information processing system according to claim 12, wherein the drawing processing unit controls the tactile feedback by the feedback unit of the brush apparatus, on an additional basis of a set drawing mode.

14. The information processing system according to claim 1, wherein the contact region estimation unit
estimates a shape of a contact region on the tip unit of the brush apparatus, on a basis of a curvature magnitude of the tip unit of the brush apparatus that is computed on a basis of the curvature information, and an angle of the tip unit of the brush apparatus with respect to the operating surface that is computed on a basis of the curvature magnitude and the brush apparatus orientation information, and
estimates a contact region on the tip unit of the brush apparatus, on a basis of a contactable region, the contactable region being a largest region on the operating surface from among regions that the tip unit of the brush apparatus is capable of contacting, and the estimated shape of the contact region on the tip unit of the brush apparatus.

15. The information processing system according to claim 14, wherein the contact region estimation unit computes an angle of the tip unit of the brush apparatus with respect to the operating surface, on an additional basis of operating surface orientation information indicating an orientation of the operating surface.

16. An information processing device comprising:
a contact region estimation unit that estimates a contact region on a tip unit, which fulfills a role of a tip on a brush of a brush apparatus that fulfills a role of a brush, and an operating surface, on a basis of curvature information indicating a curvature state of the tip unit of the brush apparatus with respect to the operating surface and brush apparatus orientation information indicating an orientation of the brush apparatus, which are transmitted from the brush apparatus, and position information indicating a contact position of the tip unit of the brush apparatus on the operating surface; and
a drawing processing unit that causes drawing according to an operation on the operating surface by the brush apparatus to be conducted on a display screen, on a basis of estimation results for the contact region.

17. A brush apparatus comprising:
a tip unit that fulfills a role of a tip on a brush;
a curvature information acquisition unit that acquires curvature information indicating a curvature state of the tip unit with respect to an operating surface;
an orientation information acquisition unit that acquires orientation information indicating an orientation of the brush apparatus; and
a communication control unit that causes the curvature information and the orientation information to be transmitted to an information processing apparatus that causes drawing according to an operation on the operating surface by the brush apparatus to be conducted on a display screen.

18. The brush apparatus according to claim 17, wherein the curvature information acquisition unit
includes an analog stick, and
takes the curvature information to be information based on an analog magnitude that corresponds to a degree of tilt of the analog stick.

19. The brush apparatus according to claim 17,
wherein the tip unit includes a conductive material whose resistance value changes depending on a curvature position, and
wherein the curvature information acquisition unit acquires the curvature information by estimating a curvature state of the tip unit from a distribution of resistance values on the tip unit.

20. The brush apparatus according to claim 17, wherein the curvature information acquisition unit acquires the curvature information by estimating a curvature state of the tip unit on a basis of relative positions of a first detection point and a second detection point on the tip unit.

21. The brush apparatus according to claim 17, further comprising:
a communication unit capable of communicating with the information processing apparatus.
